(19) United States
(12) Patent Application Publication
(10) Pub. No.: US 2014/0340617 A1
(43) Pub. Date: Nov. 20, 2014

(54) LIQUID CRYSTAL DISPLAY DEVICE

(71) Applicant: FUJIFILM Corporation, Tokyo (JP)

(72) Inventors: Yujiro YANAI, Kanagawa (JP); Yukito SAITOH, Kanagawa (JP); Hiroshi SATO, Kanagawa (JP)

(73) Assignee: FUJIFILM Corporation, Tokyo (JP)

(21) Appl. No.: 14/269,601

(22) Filed: May 5, 2014

(30) Foreign Application Priority Data
May 17, 2013 (JP) 2013-105645

(51) Int. Cl. G02F 1/1335

(52) U.S. Cl. CPC G02F 1/1335
USPC 349/96

(57) ABSTRACT

A VA-mode liquid crystal display device of four domains or less that causes less whitening and tinting, includes: a first polarizing film, a first retardation layer, a second retardation layer, a liquid crystal layer, a third retardation layer, a fourth retardation layer, and a second polarizing film, in sequence. The liquid crystal layer is in a vertical alignment mode (VA mode) under no voltage application. The first to fourth retardation layers each have a predetermined retardation. The absorption axis of the first polarizing film is orthogonal to that of the second polarizing film. The slow axis of the first retardation layer defines an angle of 45° from the absorption axis of the first polarizing film, and is parallel to the in-plane slow axis of the liquid crystal layer under voltage application. The slow axis of the first retardation layer is orthogonal to that of the fourth retardation layer.

### CROSS-REFERENCE TO RELATED APPLICATIONS

The present application claims the benefit of priority from Japanese Patent Application No. 105645/2013, filed on May 17, 2013, the contents of which are herein incorporated by reference in their entirety.

### TECHNICAL FIELD

The present invention relates to a liquid crystal display device.

### BACKGROUND ART

In the recent flat-panel display market, higher definition pixels have been pursued to improve the image quality. The progress in compact displays such as tablet PCs and smartphones is particularly remarkable. In addition, high definition televisions called 4K2K are also appearing on the market.

Among known liquid crystal modes including a TN mode, an IPS mode, and a VA mode, the VA mode is dominant in televisions. Most of the current VA modes employ a pixel division scheme called eight domains (8D).

However, the eight-domain display has a complicated pixel structure, which is unsuitable for higher definition. Furthermore, the higher definition leads to a decrease in the use efficiency of the backlight. To achieve the compatibility between a simple structure and a sufficient use efficiency of the backlight, some displays employ a pixel division scheme involving a reduced number of domains (four domains (4D) or two domains (2D)).

However, a reduced number of domains leads to whitening of images (displayed images appear brighter when viewed from the side). The whitening is caused by a difference in the gradation characteristics (where the x axis is gray level and the y axis is transmittance in a graph) between a view from the front and that from the oblique position, which phenomenon is termed γ curve, for example. Some cells and films to prevent the whitening are disclosed (Japanese Unexamined Patent Application Publication No. 2005-62724, SID 06 Digest 69.3 pp. 1946-1949; and Optics Letters Vol. 38, No. 5 pp. 799-801).

### SUMMARY OF THE INVENTION

### Problems to be Solved by the Invention

Japanese Unexamined Patent Application Publication No. 2005-62724 discloses a technique of preventing whitening with an optical film containing disk-like polymer molecules having hybrid alignment which is different alignment directions across the thickness. However, the optical film causes extreme decreasion of viewing angle contrast. SID 06 Digest 69.3 pp. 1946-1949 discloses a technique of suppressing the whitening by selecting a liquid crystal cell. However, when the whitening is suppressed by selecting a liquid crystal cell, the liquid crystals cell can be limited to the particular type. Optics Letters Vol. 38, No. 5 pp. 799-801 discloses a technique of suppressing whitening with a retardation film. However, the retardation film readily causes tinting.

An object of the invention, which has been accomplished to solve the above-described problems, is to provide a VA-mode liquid crystal display device of four domains or less that causes less whitening and tinting.

### Means for Solving the Problems

Means for solving the problems described above are shown below in <1>, preferably <2> to <7>.

<1> A liquid crystal display device comprising: a first polarizing film; a first retardation layer; a second retardation layer; a liquid crystal layer; a third retardation layer; a fourth retardation layer; and a second polarizing film, in sequence, wherein

the liquid crystal layer has four domains or less, and is in a vertical alignment mode (VA mode) under no voltage application,

the first and fourth retardation layers each have an in-plane retardation Re (550) of 25 to 125 nm at a wavelength of 550 nm, and have a thickness retardation Rth (550) of 12.5 to 62.5 nm at a wavelength of 550 nm,

the absolute value of a retardation Re (550) of the second retardation layer is not larger than 10 nm, while a retardation Rth (550) of the second retardation layer is −200 to −100 nm,

the absolute value of a retardation Re (550) of the third retardation layer is not larger than 10 nm, while a retardation Rth (550) of the third retardation layer is 300 to 400 nm,

an absorption axis of the first polarizing film is orthogonal to an absorption axis of the second polarizing film,

a slow axis of the first retardation layer defines an angle of 45° from the absorption axis of the first polarizing film, and is parallel to an in-plane slow axis of the liquid crystal layer under voltage application,

the slow axis of the first retardation layer is orthogonal to a slow axis of the fourth retardation layer, and

a product Δn·d of the refractive-index anisotropy Δn and the thickness d (μm) of the liquid crystal layer is 250 to 450 nm.

<2> A liquid crystal display device comprising: a first polarizing film; a first retardation layer; a second retardation layer; a liquid crystal layer; a third retardation layer; a fourth retardation layer; and a second polarizing film, in sequence, wherein

the liquid crystal layer has four domains or less, and is in a vertical alignment mode (VA mode) under no voltage application,

the first and fourth retardation layers each have an in-plane retardation Re (550) of 25 to 125 nm at a wavelength of 550 nm, and have a thickness retardation Rth (550) of 12.5 to 62.5 nm at a wavelength of 550 nm,

the absolute value of a retardation Re (550) of the second retardation layer is not larger than 10 nm, while a retardation Rth (550) of the second retardation layer is −300 to −200 nm,

the absolute value of a retardation Re (550) of the third retardation layer is not larger than 10 nm, while a retardation Rth (550) of the third retardation layer is 400 to 500 nm,

an absorption axis of the first polarizing film is orthogonal to an absorption axis of the second polarizing film,

a slow axis of the first retardation layer defines an angle of 45° from the absorption axis of the first polarizing film, and is orthogonal to an in-plane slow axis of the liquid crystal layer under voltage application,

the slow axis of the first retardation layer is orthogonal to a slow axis of the fourth retardation layer, and

a product Δn·d of the refractive-index anisotropy Δn and the thickness d (μm) of the liquid crystal layer is 250 to 450 nm.

<3> A liquid crystal display device comprising: a first polarizing film; a first retardation layer; a second retardation layer; a liquid crystal layer; a third retardation layer; a fourth retardation layer; and a second polarizing film, in sequence, wherein

the liquid crystal layer has four domains or less, and is in a vertical alignment mode (VA mode) under no voltage application,

the first and fourth retardation layers each have an in-plane retardation Re (550) of 25 to 125 nm at a wavelength of 550 nm, and have a thickness retardation Rth (550) of −62.5 to −12.5 nm at a wavelength of 550 nm,

the absolute value of a retardation Re (550) of the second retardation layer is not larger than 10 nm, while a retardation Rth (550) of the second retardation layer is −150 to −50 nm,

the absolute value of a retardation Re (550) of the third retardation layer is not larger than 10 nm, while a retardation Rth (550) of the third retardation layer is 400 to 500 nm,

an absorption axis of the first polarizing film is orthogonal to an absorption axis of the second polarizing film,

a slow axis of the first retardation layer defines an angle of 45° from the absorption axis of the first polarizing film, and is parallel to an in-plane slow axis of the liquid crystal layer under voltage application,

the slow axis of the first retardation layer is orthogonal to a slow axis of the fourth retardation layer, and

a product Δn·d of the refractive-index anisotropy Δn and the thickness d (μm) of the liquid crystal layer is 250 to 450 nm.

<4> A liquid crystal display device comprising: a first polarizing film; a first retardation layer; a second retardation layer; a liquid crystal layer; a third retardation layer; a fourth retardation layer; and a second polarizing film, in sequence, wherein

the liquid crystal layer has four domains or less, and is in a vertical alignment mode (VA mode) under no voltage application,

the first and fourth retardation layers each have an in-plane retardation Re (550) of 25 to 125 nm at a wavelength of 550 nm, and have a thickness retardation Rth (550) of −62.5 to −12.5 nm at a wavelength of 550 nm,

the absolute value of a retardation Re (550) of the second retardation layer is not larger than 10 nm, while a retardation Rth (550) of the second retardation layer is −200 to −100 nm,

the absolute value of a retardation Re (550) of the third retardation layer is not larger than 10 nm, while a retardation Rth (550) of the third retardation layer is 400 to 500 nm,

an absorption axis of the first polarizing film is orthogonal to an absorption axis of the second polarizing film,

a slow axis of the first retardation layer defines an angle of 45° from the absorption axis of the first polarizing film, and is orthogonal to an in-plane slow axis of the liquid crystal layer under voltage application,

the slow axis of the first retardation layer is orthogonal to a slow axis of the fourth retardation layer, and

a product Δn·d of the refractive-index anisotropy Δn and the thickness d (μm) of the liquid crystal layer is 250 to 450 nm.

<5> The liquid crystal display device according to any one of <1> to <4>, wherein at least one of the first retardation layer, the second retardation layer, the third retardation layer, and the fourth retardation layer comprises an optically anisotropic layer containing a liquid crystalline compound.
<6> The liquid crystal display device according to any one of <1> to <5>, further comprising a fifth retardation layer between the first polarizing film and the first retardation layer or between the second polarizing film and the fourth retardation layer.
<7> The liquid crystal display device according to <6>, wherein the fifth retardation layer is a laminated film comprising:

a film having a retardation Re (550) of 70 to 140 nm and a retardation Rth (550) of 40 to 110 nm; and

a film having a retardation Re (550) of not larger than 10 nm and a retardation Rth (550) of −180 to −90 nm.

### Advantages of the Invention

The invention can achieve a VA-mode liquid crystal display device of four domains or less that causes less whitening and tinting.

### BRIEF DESCRIPTION OF THE DRAWINGS

FIG. 1 is a schematic diagram illustrating an example structure of a liquid crystal display device according to the invention;

FIG. 2 is a schematic diagram illustrating an example structure of a conventional liquid crystal display device;

FIG. 3 is a schematic diagram illustrating an example structure of a liquid crystal display device according to first and third embodiments of the invention; and

FIG. 4 is a schematic diagram illustrating an example structure of a liquid crystal display device according to second and fourth embodiments of the invention.

### BEST MODE FOR CARRYING OUT THE INVENTION

The present invention will be explained in detail below. As used herein, the numerical ranges expressed with “to” are used to mean the ranges including the values indicated before and after “to” as lower and upper limits.

Throughout the specification, the term “slow axis” indicates a direction providing a maximum refractive index.

Throughout the specification, the terms, such as “45°,” “parallel,” and “perpendicular” or “orthogonal,” each allow an error less than ±5° from the exact angle, unless otherwise stated. In other words, these terms indicate substantially 45°, substantially parallel, and substantially perpendicular, respectively. The error from the exact angle is preferably less than ±4°, and more preferably less than ±3°. Regarding angles, the sign “+” indicates the counterclockwise direction and the sign “−” indicates the clockwise direction.

The angles of the slow axes and absorption axes are defined such that the absorption axis of the first polarizing film is 0° and the counterclockwise direction as viewed from a viewer is positive.

The liquid crystal display device according to the invention includes a first polarizing film, a first retardation layer, a second retardation layer, a liquid crystal layer, a third retardation layer, a fourth retardation layer, and a second polarizing film, in sequence. The liquid crystal layer has four domains or less, and is in a vertical alignment mode (VA mode) under no voltage application. The first to fourth retardation layers each have a predetermined retardation. The absorption axis of the first polarizing film is orthogonal to that of the second polarizing film. The slow axis of the first retardation layer defines an angle of 45° from the absorption axis of the first polarizing film, and is parallel to the in-plane slow axis of the liquid crystal layer under voltage application. The slow axis of the first retardation layer is orthogonal to that of the fourth retardation layer. These configurations allow the liquid crystal display device not to cause whitening or tinting. The term “tinting” indicates a phenomenon that tint appears when a film having a retardation Re of larger than λ/2 is interposed between two polarizing films.

In addition, the liquid crystal display device can achieve high viewing angle contrast while maintaining high front contrast.

Various techniques of preventing whitening have been examined. SID 06 Digest 69.3 pp. 1946-1949 discloses a technique of using different voltage application modes between pixels A (four domains) and pixels B (four domains) to display an average image. That is, the cell itself prevents whitening in the cited reference.

Optics Letters Vol. 38, No. 5 pp. 799-801 discloses a retardation film preventing whitening. However, the present inventors have found that tinting occurs in the cited reference. This respect will now be described in detail with reference to the drawings.

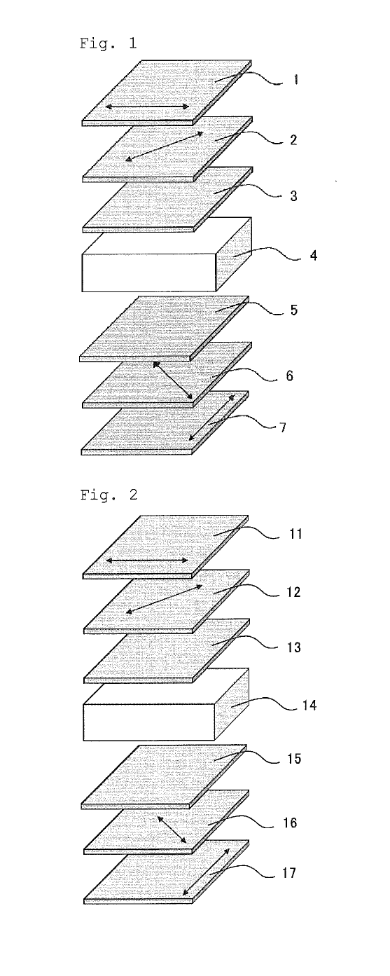

FIG. 1 is a schematic diagram illustrating an example structure of the liquid crystal display device according to the invention. A first polarizing film 1, a first retardation layer 2, a second retardation layer 3, a liquid crystal layer 4, a third retardation layer 5, and a second polarizing film 6 are laminated in order from the top. The liquid crystal display device disclosed in Optics Letters Vol. 38, No. 5 pp. 799-801 has a structure illustrated in FIG. 2. In contrast to FIG. 1, a first polarizing film 11, a first retardation layer 12, a fourth retardation layer 13, a liquid crystal layer 14, a second retardation layer 15, a third retardation layer 16, and a second polarizing film 17 are laminated in order from the top. The table below illustrates example retardations (unit: nm) at a wavelength of 550 nm for each of the retardation layers in FIGS. 1 and 2.

TABLE 1

| | | | Optics Letters | | |
|---|---|---|---|---|---|
| | | | Vol. 38, No. 5 | | |
| Present invention | R e | R t h | p. 799-801 | R e | R t h |
| First polarizing | | | First polarizing | | |
| film | | | film | | |
| First retardation | 75 | 37.5 | First retardation | 320 | 160 |
| layer | | | layer | | |
| Second retardation | 0 | −150 | Fourth retardation | 275 | 0 |
| layer | | | layer | | |
| Liquid crystal | | | Liquid crystal | | |
| layer | | | layer | | |
| Third retardation | 0 | 350 | Second retardation | 0 | 300 |
| layer | | | layer | | |
| Fourth retardation | 75 | 37.5 | Third retardation | 320 | −160 |
| layer | | | layer | | |
| Second polarizing | | | Second polarizing | | |
| film | | | film | | |

As shown in the table, the retardation Re of the first retardation layer 12 in FIG. 2 is 320 nm, which significantly exceeds λ/2 causing tinting.

The difference between FIGS. 1 and 2 will now be described in more detail.

The structure illustrated in FIG. 1 and the optical characteristics within predetermined numeric ranges can reduce the effects caused by the birefringence of liquid crystal molecules in the liquid crystal cell under voltage application.

In FIGS. 1 and 2, the polarized light is shifted such that one of the axes of individual polarization states after passing through the third and fourth retardation layers is substantially parallel to the direction providing the maximum refractive index of the liquid crystal molecules in the liquid crystal cell, while the other of the axes is substantially parallel to the direction providing the minimum refractive index. Both configurations therefore do not significantly affect a shift of polarized light caused by the liquid crystal molecules in the liquid crystal cell.

The first and second retardation layers restore a polarization state after passing through the liquid crystal layer to a polarization state after passing through the second polarization film. The above-described order of layers leads to an improvement in the gradation characteristics.

The liquid crystal display device according to the invention includes a first polarizing film, a first retardation layer, a second retardation layer, a liquid crystal layer, a third retardation layer, a fourth retardation layer, and a second polarizing film, in sequence. In FIG. 1, either the top surface (the outer surface of the first polarizing film) or the bottom surface (the outer surface of the second polarizing film) may be on the side of a viewer. Each of the first retardation layer, the second retardation layer, the third retardation layer, the fourth retardation layer, and the other retardation layers may have a single-layer or multi-layer configuration. It is preferred that at least one of the retardation layers be provided with an optically anisotropic layer containing a liquid crystalline compound.

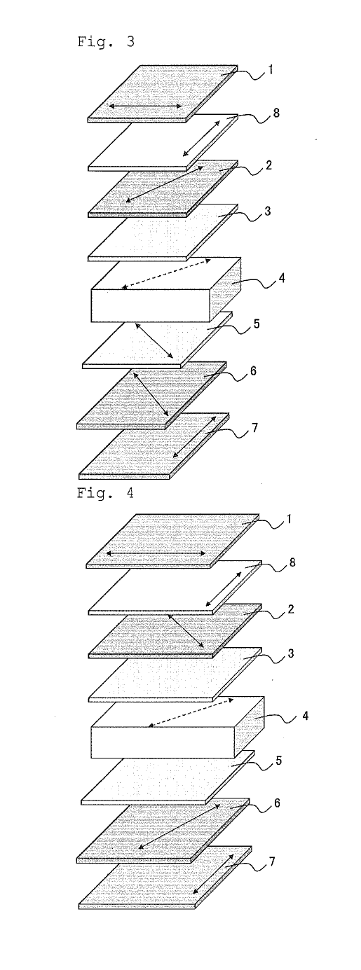

The liquid crystal display device according to the invention will now be described in more detail, regarding the first and third embodiments having an example structure illustrated in FIG. 3, and the second and fourth embodiments having an example structure illustrated in FIG. 4. FIGS. 3 and 4 use reference signs common to FIG. 1. These embodiments will now be described in detail.

### First Embodiment

FIG. 3 illustrates an example structure of a liquid crystal display device according to the first embodiment of the invention. The device includes a first polarizing film, a first retardation layer, a second retardation layer, a liquid crystal layer, a third retardation layer, a fourth retardation layer, and a second polarizing film, in sequence. The liquid crystal layer has four domains or less, and is in a vertical alignment mode (VA mode) under no voltage application. The first and fourth retardation layers each have an in-plane retardation Re (550) of 25 to 125 nm at a wavelength of 550 nm, and have a thickness retardation Rth (550) of 12.5 to 62.5 nm at a wavelength of 550 nm. The absolute value of the retardation Re (550) of the second retardation layer is 10 nm or smaller, while the retardation Rth (550) of the second retardation layer is −200 to −100 nm. The absolute value of the retardation Re (550) of the third retardation layer is 10 nm or smaller, while the retardation Rth (550) of the third retardation layer is 300 to 400 nm. The absorption axis of the first polarizing film is orthogonal to that of the second polarizing film. The slow axis of the first retardation layer defines an angle of 45° from the absorption axis of the first polarizing film, and is parallel to the in-plane slow axis of the liquid crystal layer under voltage application. The slow axis of the first retardation layer is orthogonal to that of the fourth retardation layer. The product Δn·d of the refractive-index anisotropy Δn and the thickness d (μm) of the liquid crystal layer is 250 to 450 nm.

The absorption axis of the first polarizing film is orthogonal to that of the second polarizing film. The polarizing films may be any known polarizing film. For example, the relevant description in paragraph 0090 of Japanese Unexamined Patent Application Publication No. 2012-150377 is incorporated herein by reference.

The first retardation layer is disposed between the first polarizing film and the second retardation layer. The first retardation layer has a retardation Re (550) of 25 to 125 nm and has a retardation Rth (550) of 12.5 to 62.5 nm. The first retardation layer prevents whitening in cooperation with the fourth retardation layer.

The retardation Re (550) of the first retardation layer is preferably 40 to 110 nm, and more preferably 55 to 95 nm. The retardation Rth (550) of the first retardation layer is preferably 20 to 55 nm, and more preferably 27.5 to 47.5 nm. A typical example of such a film is a positive A-plate.

The first retardation layer may be fabricated by any known process so as to have the above-mentioned retardations. Examples of the process include the formation of an optically anisotropic layer containing a liquid crystal compound (in particular, such that rod-like liquid crystal molecules are horizontally aligned), the addition of a retardation adjustor, and/or stretching. For more details, the description of Japanese Patent No. 4825934 is incorporated herein by reference.

In terms of a reduction in thickness of the liquid crystal display device, the first retardation layer is preferably fabricated by forming an optically anisotropic layer containing a liquid crystal compound. The first retardation layer formed with the optically anisotropic layer containing a liquid crystal compound can achieve a thickness of approximately 1.0 to 2.0 μm.

The slow axis of the first retardation layer (e.g., the arrow in the first retardation layer 2 in FIG. 3) and the absorption axis of the first polarizing film (e.g., the arrow in the first polarizing film 1 in FIG. 3) define an angle of 45°. The slow axis of the first retardation layer is parallel to the in-plane slow axis of the liquid crystal layer (e.g., the dashed arrow in the liquid crystal layer 4 in FIG. 3) under voltage application.

The second retardation layer is disposed between the first retardation layer and the liquid crystal layer. The absolute value of the retardation Re (550) of the second retardation layer is 10 nm or less, while the retardation Rth (550) of the second retardation layer is −200 to −100 nm. The second retardation layer functions as a compensator for the liquid crystal layer. It is therefore preferred that the second retardation layer and the liquid crystal layer retain no retardation layer therebetween. According to the invention, the second retardation layer is disposed near the first retardation layer. This configuration can reduce the retardation Re of the first retardation layer, to prevent tinting.

The retardation Rth (550) of the second retardation layer is preferably −190 to −110 nm, and more preferably −180 to −120 nm.

The absolute value of the retardation Re (550) of the second retardation layer is preferably 5 nm or less, and more preferably substantially 0 nm. A typical example of such a film is a positive C-plate.

The second retardation layer may be fabricated by any known process so as to have the above-mentioned retardations. Examples of the process include the formation of an optically anisotropic layer containing a liquid crystalline compound (in particular, such that rod-like liquid crystal molecules are vertically aligned). For more details, the description of Japanese Patent No. 5036209 is incorporated herein by reference.

In terms of a reduction in thickness of the liquid crystal display device, the second retardation layer is preferably fabricated by forming an optically anisotropic layer containing a liquid crystalline compound. The second retardation layer should preferably include an optically anisotropic layer containing a liquid crystalline compound to achieve a thickness of approximately 0.5 to 3.0 μm.

The liquid crystal layer according to the invention has four domains or less, and is in a vertical alignment mode (VA mode) under no voltage application. The liquid crystal layer may have four domains or two domains, and four domains are preferred.

The retardation of the VA-mode liquid crystal layer (i.e., the product Δnd of the refractive-index anisotropy Δn and the thickness d (μm) of the liquid crystal layer) is 250 to 450 nm, preferably 275 to 425 nm, and more preferably 300 to 400 nm. In the below-described examples of the invention, the retardation of the liquid crystal layer is referred to as Rth (Rth=−Δnd).

While no voltage is being applied to the liquid crystal cell (i.e., in a black display mode), the direction providing a maximum refractive index is substantially perpendicular to the substrate in the liquid crystal of the liquid crystal cell. The liquid crystal layer is therefore considered to be a positive C-plate.

For more details of the VA-mode liquid crystal cell and liquid crystal layer, the description of Japanese Unexamined Patent Application Publication No. 2013-076749 (in particular, paragraphs 0185 to 0187) is incorporated herein by reference.

The third retardation layer is disposed between the fourth retardation layer and the liquid crystal layer. The absolute value of the retardation Re (550) of the third retardation layer is 10 nm or smaller, while the retardation Rth (550) of the third retardation layer is 300 to 400 nm. The third retardation layer functions as a compensator for the liquid crystal layer in cooperation with the second retardation layer. It is therefore preferred that the third retardation layer and the liquid crystal layer retain no retardation layer therebetween.

The retardation Rth (550) of the third retardation layer is preferably 310 to 390 nm, and more preferably 320 to 380 nm.

The absolute value of the retardation Re (550) of the third retardation layer is preferably 5 nm or less, and more preferably substantially 0 nm. A typical example of such a film is a negative C-plate.

In the liquid crystal display device according to the first embodiment, a difference in the retardation Re (550) between the second retardation layer and the third retardation layer should preferably be small. The difference in the absolute value of the retardation Re (550) between the second retardation layer and the third retardation layer is 10 nm or less, preferably 5 nm or less, and more preferably substantially 0 nm.

The third retardation layer may be fabricated by any known process so as to have the above-mentioned retardations. Examples of the process include the formation of an optically anisotropic layer containing a liquid crystalline compound (in particular, such that discotic liquid crystal molecules are horizontally aligned). For more details, the description of Japanese Unexamined Patent Application Publication No. 2008-40309 is incorporated herein by reference.

In terms of a reduction in thickness of the liquid crystal display device, the third retardation layer is preferably fabricated by forming an optically anisotropic layer containing a liquid crystalline compound. The third retardation layer should preferably include an optically anisotropic layer containing a liquid crystalline compound to achieve a thickness of approximately 2.0 to 5.0 μm.

The fourth retardation layer is disposed between the second polarizing film and the third retardation layer. The retardation Re (550) of the fourth retardation layer is 25 to 125 nm, while the retardation Rth (550) of the fourth retardation layer is 12.5 to 62.5 nm.

The retardation Re (550) of the fourth retardation layer is preferably 40 to 110 nm, and more preferably 55 to 95 nm. The retardation Rth (550) of the fourth retardation layer is preferably 20 to 55 nm, and more preferably 27.5 to 47.5 nm. A typical example of such a film is a positive A-plate.

The first retardation layer and the fourth retardation layer prevent whitening in cooperation, as described above. In the liquid crystal display device according to the invention, a reduced difference in the retardation Re (550) between the first retardation layer and the fourth retardation layer leads to more effective prevention of whitening. The difference in the absolute value of the retardation Re (550) between the first retardation layer and the fourth retardation layer is 10 nm or less, preferably 5 nm or less, and more preferably substantially 0 nm.

The difference in the absolute value of the retardation Rth (550) between the first retardation layer and the fourth retardation layer is 10 nm or less, preferably 5 nm or less, and more preferably substantially 0 nm. This configuration can more effectively enhance the front contrast.

The fourth retardation layer may be fabricated by any known process so as to have the above-mentioned retardations. Examples of the process include the formation of an optically anisotropic layer containing a liquid crystalline compound (in particular, such that rod-like liquid crystal molecules are horizontally aligned), the addition of a retardation adjustor, and/or stretching. For more details, the description of Japanese Patent No. 4825934 is incorporated herein by reference.

In terms of a reduction in thickness of the liquid crystal display device, the fourth retardation layer is preferably fabricated by forming an optically anisotropic layer containing a liquid crystalline compound. The fourth retardation layer should preferably include an optically anisotropic layer containing a liquid crystalline compound to achieve a thickness of approximately 0.1 to 2.0 μm.

The slow axis of the fourth retardation layer (e.g., the arrow in the fourth retardation layer 6 in FIG. 3) is orthogonal to the slow axis of the first retardation layer (e.g., the arrow in the first retardation layer 2 in FIG. 3).

If the liquid crystal layer has four domains, the fourth retardation layer is a patterned retardation layer (the same can also be applied to the second to fourth embodiments below). A technique to form a patterned retardation layer is disclosed in Japanese Unexamined Patent Application Publication No. 2013-011800, Japanese Unexamined Patent Application Publication No. 2013-068924, and Published Japanese Translation of PCT International Patent Publication No. 2012-517024, which are incorporated herein by reference.

The liquid crystal layer having four domains may have a horizontal stripe pattern. Such horizontal stripe patterns are disclosed in Y. Tanaka, Y. Taniguchi, T. Sasaki, A. Takeda, Y. Koibe, and K. Okamoto, “A New Design to Improve Performance and Simplify the Manufacturing Process of High-Quality MVA TFT-LCD Panels”, SID Symposium Digest, p. 206, 1999; and K. H. Kim, K. H. Lee, S. B. Park, J. K. Song, S. N. Kim, and J. H. Souk, Asia Display '98, p. 383, 1998, which are incorporated herein by reference.

The liquid crystal display device according to the invention can provide the same effects in both cases where a viewer is on the side of the first polarizing film and where the viewer is on the side of the second polarizing film, provided that the order of the layers is maintained (the same can also be applied to the second to fourth embodiments below).

The liquid crystal display device according to the invention may include another layer, within the gist of the invention. For example, a fifth retardation layer may be disposed between the first polarizing film and the first retardation layer, or between the second polarizing film and the fourth retardation layer. In FIG. 3, a fifth retardation layer 8 is disposed between the first polarizing film and the first retardation layer. It is preferred that the slow axis of the fifth retardation layer (e.g., the arrow in the fifth retardation layer 8 in FIG. 3) be orthogonal to the absorption axis of the first polarizing film (e.g., the arrow in the first polarizing film 1 in FIG. 3). The fifth retardation layer 8 can compensate for the polarizing films, and further enhances the contrast in views from diagonal directions (viewing angle CR).

The fifth retardation layer may have a single-layer or multi-layer configuration.

In the single-layer configuration, the retardation Re (550) is preferably 250 to 305 nm, and more preferably 260 to 290 nm; while the retardation Rth (550) is preferably −30 to 30 nm, and more preferably −15 to 15 nm. The single-layer configuration, however, cannot easily control the wavelength dispersion, and readily causes black tint in views from diagonal directions.

The fifth retardation layer preferably has a multi-layer configuration to reduce black tint. The layer configuration of a biaxial film and a positive C-plate is most preferable among a variety of possible combinations. The retardation Re (550) of the biaxial film is preferably 70 to 140 nm, and more preferably 90 to 120 nm; while the retardation Rth (550) of the biaxial film is preferably 40 to 110 nm, and more preferably 90 to 110 nm. The retardation Re (550) of the positive C-plate is preferably 10 nm or less; while the retardation Rth (550) of the positive C-plate is preferably −180 to −90 nm, and more preferably −180 to −130 nm.

A wide variety of known retardation films for compensation for polarizing films can be applied. For more details of a single-layer configuration, the description of Japanese Unexamined Patent Application Publication No. 2009-235374 is incorporated herein by reference. For more details of a multi-layer configuration, the description of Japanese Unexamined Patent Application Publication No. 2012-8548 is incorporated herein by reference.

Any of the first to fourth retardation layers may consist of an in-cell structure (the same can also be applied to the second to fourth embodiments below). Such an in-cell structure more readily prevents whitening. If the first retardation layer consists of an in-cell structure, it is preferred that the fourth retardation layer also consist of an in-cell structure.

### Second Embodiment

FIG. 4 illustrates an example structure of a liquid crystal display device according to the second embodiment of the invention. The device includes a first polarizing film, a first retardation layer, a second retardation layer, a liquid crystal layer, a third retardation layer, a fourth retardation layer, and a second polarizing film, in sequence. The liquid crystal layer has four domains or less, and is in a vertical alignment mode (VA mode) under no voltage application. The first and fourth retardation layers each have an in-plane retardation Re (550) of 25 to 125 nm at a wavelength of 550 nm, and have a thickness retardation Rth (550) of 12.5 to 62.5 nm at a wavelength of 550 nm. The absolute value of the retardation Re (550) of the second retardation layer is 10 nm or less, while the retardation Rth (550) of the second retardation layer is −300 to −200 nm. The absolute value of the retardation Re (550) of the third retardation layer is 10 nm or less, while the retardation Rth (550) of the third retardation layer is 400 to 500 nm. The absorption axis of the first polarizing film is orthogonal to that of the second polarizing film. The slow axis of the first retardation layer defines an angle of 45° from the absorption axis of the first polarizing film, and is orthogonal to the in-plane slow axis of the liquid crystal layer under voltage application. The slow axis of the first retardation layer is orthogonal to that of the fourth retardation layer. The product Δn·d of the refractive-index anisotropy Δn and the thickness d (μm) of the liquid crystal layer is 250 to 450 nm.

The second embodiment is identical to the first embodiment in terms of the first and second polarizing films, the liquid crystal layer, and the first and fourth retardation layers, and their preferred numeric ranges, except for the directions of the slow axes of the first and fourth retardation layers.

The slow axis of the first retardation layer (e.g., the arrow in the first retardation layer 2 in FIG. 4) and the absorption axis of the first polarizing film (e.g., the arrow in the first polarizing film 1 in FIG. 4) define an angle of 45°. The slow axis of the first retardation layer is orthogonal to the in-plane slow axis of the liquid crystal layer (e.g., the dashed arrow in the liquid crystal layer 4 in FIG. 4) under voltage application.

The second retardation layer is disposed between the first retardation layer and the liquid crystal layer. The absolute value of the retardation Re (550) of the second retardation layer is 10 nm or less, while the retardation Rth (550) of the second retardation layer is −300 to −200 nm. The second retardation layer functions as a compensator for the liquid crystal layer. It is therefore preferred that the second retardation layer and the liquid crystal layer retain no retardation layer therebetween. According to the invention, the second retardation layer is disposed near the first retardation layer. This configuration can reduce the retardation Re of the first retardation layer, to prevent tinting.

The retardation Rth (550) of the second retardation layer is preferably −290 to −210 nm, and more preferably −280 to −220 nm.

The absolute value of the retardation Re (550) of the second retardation layer is preferably 5 nm or less, and more preferably substantially 0 nm. A typical example of such a film is a positive C-plate.

The second retardation layer may be fabricated by any known process so as to have the above-mentioned retardations. A typical example of the process is explained above in the description regarding the second retardation layer in the first embodiment.

In terms of a reduction in thickness of the liquid crystal display device, the second retardation layer is preferably fabricated by forming an optically anisotropic layer containing a liquid crystalline compound. The second retardation layer should preferably include an optically anisotropic layer containing a liquid crystalline compound to achieve a thickness of approximately 1.5 to 4.0 μm.

The third retardation layer is disposed between the fourth retardation layer and the liquid crystal layer. The absolute value of the retardation Re (550) of the third retardation layer is 10 nm or less, while the retardation Rth (550) of the third retardation layer is 400 to 500 nm. The third retardation layer functions as a compensator for the liquid crystal layer in cooperation with the second retardation layer. It is therefore preferred that the third retardation layer and the liquid crystal layer retain no retardation layer therebetween.

The retardation Rth (550) of the third retardation layer is preferably 410 to 490 nm, and more preferably 420 to 480 nm.

The absolute value of the retardation Re (550) of the third retardation layer is preferably 5 nm or less, and more preferably substantially 0 nm. A typical example of such a film is a negative C-plate.

In the liquid crystal display device according to the second embodiment, the difference in the retardation Re (550) between the second retardation layer and the third retardation layer should preferably be small. The difference in the absolute value of the retardation Re (550) between the second retardation layer and the third retardation layer is 10 nm or less, preferably 5 nm or less, and more preferably substantially 0 nm.

The third retardation layer may be fabricated by any known process so as to have the above-mentioned retardations. A typical example of the process is explained above in the description regarding the third retardation layer in the first embodiment.

In terms of a reduction in thickness of the liquid crystal display device, the third retardation layer is preferably fabricated by forming an optically anisotropic layer containing a liquid crystalline compound. The third retardation layer should preferably include an optically anisotropic layer containing a liquid crystalline compound to achieve a thickness of approximately 3.0 to 6.0 μm.

The fourth retardation layer is disposed between the second polarizing film and the third retardation layer. The retardation Re (550) of the fourth retardation layer is 25 to 125 nm, while the retardation Rth (550) of the fourth retardation layer is 12.5 to 62.5 nm. The fourth retardation layer prevents whitening in cooperation with the first retardation layer.

The retardation Re (550) of the fourth retardation layer is preferably 40 to 110 nm, and more preferably 55 to 95 nm. The retardation Rth (550) of the fourth retardation layer is preferably 20 to 55 nm, and more preferably 27.5 to 47.5 nm. A typical example of such a film is a positive A-plate.

The first retardation layer and the fourth retardation layer prevent whitening in cooperation, as described above. In the liquid crystal display device according to the invention, a reduced difference in the retardation Re (550) between the first retardation layer and the fourth retardation layer leads to more effective prevention of whitening. The difference in the absolute value of the retardation Re (550) between the first retardation layer and the fourth retardation layer is 10 nm or less, preferably 5 nm or less, and more preferably substantially 0 nm.

The difference in the absolute value of the retardation Rth (550) between the first retardation layer and the fourth retardation layer is 10 nm or less, preferably 5 nm or less, and more preferably substantially 0 nm. This configuration can more effectively enhance the front contrast.

The fourth retardation layer may be fabricated by any known process so as to have the above-mentioned retardations. A typical example of the process is explained above in the description regarding the first retardation layer.

In terms of a reduction in thickness of the liquid crystal display device, the fourth retardation layer is preferably fabricated by forming an optically anisotropic layer containing a liquid crystalline compound. The fourth retardation layer should preferably include an optically anisotropic layer containing a liquid crystalline compound to achieve a thickness of approximately 0.1 to 2.0 μm.

The slow axis of the fourth retardation layer (e.g., the arrow in the fourth retardation layer 6 in FIG. 4) is orthogonal to the slow axis of the first retardation layer (e.g., the arrow in the first retardation layer 2 in FIG. 4).

The liquid crystal display device according to the embodiment in FIG. 4 further includes a fifth retardation layer 8. The details of the fifth retardation layer and its preferred numeric ranges are described above in the first embodiment.

### Third Embodiment

FIG. 3 illustrates an example structure of a liquid crystal display device according to the third embodiment of the invention. The device includes a first polarizing film, a first retardation layer, a second retardation layer, a liquid crystal layer, a third retardation layer, a fourth retardation layer, and a second polarizing film, in sequence. The liquid crystal layer has four domains or less, and is in a vertical alignment mode (VA mode) under no voltage application. The first and fourth retardation layers each have an in-plane retardation Re (550) of 25 to 125 nm at a wavelength of 550 nm, and have a thickness retardation Rth (550) of −62.5 to −12.5 nm at a wavelength of 550 nm. The absolute value of the retardation Re (550) of the second retardation layer is 10 nm or less, while the retardation Rth (550) of the second retardation layer is −150 to −50 nm. The absolute value of the retardation Re (550) of the third retardation layer is 10 nm or less, while the retardation Rth (550) of the third retardation layer is 400 to 500 nm. The absorption axis of the first polarizing film is orthogonal to that of the second polarizing film. The slow axis of the first retardation layer defines an angle of 45° from the absorption axis of the first polarizing film, and is parallel to the in-plane slow axis of the liquid crystal layer under voltage application. The slow axis of the first retardation layer is orthogonal to that of the fourth retardation layer. The product Δn·d of the refractive-index anisotropy Δn and the thickness d (μm) of the liquid crystal layer is 250 to 450 nm.

The third embodiment is identical to the first embodiment in terms of the first and second polarizing films and the liquid crystal layer, and their preferred numeric ranges.

The first retardation layer is disposed between the first polarizing film and the second retardation layer. The first retardation layer has a retardation Re (550) of 25 to 125 nm and has a retardation Rth (550) of −62.5 to −12.5 nm. The first retardation layer prevents whitening in cooperation with the fourth retardation layer.

The retardation Re (550) of the first retardation layer is preferably 40 to 110 nm, and more preferably 55 to 95 nm. The retardation Rth (550) of the first retardation layer is preferably −55 to −20 nm, and more preferably −47.5 to −27.5 nm. A typical example of such a film is a negative A-plate.

The first retardation layer may be fabricated by any known process so as to have the above-mentioned retardations. Examples of the process include the formation of an optically anisotropic layer containing a liquid crystalline compound (in particular, such that discotic liquid crystal molecules are vertically aligned), the addition of a retardation adjustor, and/or stretching. For more details, the description of Japanese Unexamined Patent Application Publication No. 2012-018396 is incorporated herein by reference.

The second retardation layer is disposed between the first retardation layer and the liquid crystal layer. The absolute value of the retardation Re (550) of the second retardation layer is 10 nm or less, while the retardation Rth (550) of the second retardation layer is −150 to −50 nm. The second retardation layer functions as a compensator for the liquid crystal layer. It is therefore preferred that the second retardation layer and the liquid crystal layer retain no retardation layer therebetween. According to the invention, the second retardation layer is disposed near the first retardation layer. This configuration can reduce the retardation Re of the first retardation layer, to prevent tinting.

The retardation Rth (550) of the second retardation layer is preferably −140 to −60 nm, and more preferably −130 to −70 nm.

The absolute value of the retardation Re (550) of the second retardation layer is preferably 5 nm or less, and more preferably substantially 0 nm. A typical example of such a film is a positive C-plate.

The second retardation layer may be fabricated by any known process so as to have the above-mentioned retardations. A typical example of the process is explained above in the description regarding the second retardation layer in the first embodiment.

In terms of a reduction in thickness of the liquid crystal display device, the second retardation layer is preferably fabricated by forming an optically anisotropic layer containing a liquid crystalline compound. The second retardation layer should preferably include an optically anisotropic layer containing a liquid crystalline compound to achieve a thickness of approximately 0.3 to 2.5 μm.

The third retardation layer is disposed between the fourth retardation layer and the liquid crystal layer. The absolute value of the retardation Re (550) of the third retardation layer is 10 nm or less, while the retardation Rth (550) of the third retardation layer is 400 to 500 nm. The third retardation layer functions as a compensator for the liquid crystal layer in cooperation with the second retardation layer. It is therefore preferred that the third retardation layer and the liquid crystal layer retain no retardation layer therebetween.

The retardation Rth (550) of the third retardation layer is preferably 410 to 490 nm, and more preferably 420 to 480 nm.

The absolute value of the retardation Re (550) of the third retardation layer is preferably 5 nm or less, and more preferably substantially 0 nm. A typical example of such a film is a negative C-plate.

In the liquid crystal display device according to the third embodiment, the difference in the retardation Re (550) between the second retardation layer and the third retardation layer should preferably be small. The difference in the absolute value of the retardation Re (550) between the second retardation layer and the third retardation layer is 10 nm or less, preferably 5 nm or less, and more preferably substantially 0 nm.

The third retardation layer may be fabricated by any known process so as to have the above-mentioned retardations. A typical example of the process is explained above in the description regarding the second retardation layer in the first embodiment.

In terms of a reduction in thickness of the liquid crystal display device, the third retardation layer is preferably fabricated by forming an optically anisotropic layer containing a liquid crystalline compound. The third retardation layer should preferably include an optically anisotropic layer containing a liquid crystalline compound to achieve a thickness of approximately 3.0 to 6.0 μm.

The fourth retardation layer is disposed between the second polarizing film and the third retardation layer. The retardation Re (550) of the fourth retardation layer is 25 to 125 nm, while the retardation Rth (550) of the fourth retardation layer is −62.5 to −12.5 nm.

The retardation Re (550) of the fourth retardation layer is preferably 40 to 110 nm, and more preferably 55 to 95 nm. The retardation Rth (550) of the fourth retardation layer is preferably −55 to −20 nm, and more preferably −47.5 to −27.5 nm. A typical example of such a film is a negative A-plate.

The first retardation layer and the fourth retardation layer prevent whitening in cooperation, as described above. In the liquid crystal display device according to the invention, a reduced difference in the retardation Re (550) between the first retardation layer and the fourth retardation layer leads to more effective prevention of whitening. The difference in the absolute value of the retardation Re (550) between the first retardation layer and the fourth retardation layer is 10 nm or less, preferably 5 nm or less, and more preferably substantially 0 nm.

The difference in the absolute value of the retardation Rth (550) between the first retardation layer and the fourth retardation layer is 10 nm or less, preferably 5 nm or less, and more preferably substantially 0 nm. This configuration can more effectively enhance the front contrast.

The fourth retardation layer may be fabricated by any known process so as to have the above-mentioned retardations. Examples of the process include the formation of an optically anisotropic layer containing a liquid crystalline compound (in particular, such that discotic liquid crystal molecules are vertically aligned), the addition of a retardation adjustor, and/or stretching. For more details, the description of Japanese Unexamined Patent Application Publication No. 2012-018396 is incorporated herein by reference.

The liquid crystal display device according to the third embodiment further includes a fifth retardation layer 8. The details of the fifth retardation layer and its preferred numeric ranges are described above in the first embodiment.

### Fourth Embodiment

FIG. 4 illustrates an example structure of a liquid crystal display device according to the fourth embodiment of the invention. The device includes a first polarizing film, a first retardation layer, a second retardation layer, a liquid crystal layer, a third retardation layer, a fourth retardation layer, and a second polarizing film, in sequence. The liquid crystal layer has four domains or less, and is in a vertical alignment mode (VA mode) under no voltage application. The first and fourth retardation layers each have an in-plane retardation Re (550) of 25 to 125 nm at a wavelength of 550 nm, and have a thickness retardation Rth (550) of −62.5 to −12.5 nm at a wavelength of 550 nm. The absolute value of the retardation Re (550) of the second retardation layer is 10 nm or less, while the retardation Rth (550) of the second retardation layer is −200 to −100 nm. The absolute value of the retardation Re (550) of the third retardation layer is 10 nm or less, while the retardation Rth (550) of the third retardation layer is 400 to 500 nm. The absorption axis of the first polarizing film is orthogonal to that of the second polarizing film. The slow axis of the first retardation layer defines an angle of 45° from the absorption axis of the first polarizing film, and is orthogonal to the in-plane slow axis of the liquid crystal layer under voltage application. The slow axis of the first retardation layer is orthogonal to that of the fourth retardation layer. The product Δn·d of the refractive-index anisotropy Δn and the thickness d (μm) of the liquid crystal layer is 250 to 450 nm.

The fourth embodiment is identical to the third embodiment in terms of the first and second polarizing films and the liquid crystal layer, and their preferred numeric ranges.

The fourth embodiment is identical to the third embodiment in terms of the first and fourth retardation layers and their preferred numeric ranges.

The second retardation layer is disposed between the first retardation layer and the liquid crystal layer. The absolute value of the retardation Re (550) of the second retardation layer is 10 nm or less, while the retardation Rth (550) of the second retardation layer is −200 to −100 nm. The second retardation layer functions as a compensator for the liquid crystal layer. It is therefore preferred that the second retardation layer and the liquid crystal layer retain no retardation layer therebetween. According to the invention, the second retardation layer is disposed near to the first retardation layer. This configuration can reduce the retardation Re of the first retardation layer, to prevent tinting.

The retardation Rth (550) of the second retardation layer is preferably −190 to −110 nm, and more preferably −180 to −120 nm.

The absolute value of the retardation Re (550) of the second retardation layer is preferably 5 nm or less, and more preferably substantially 0 nm. A typical example of such a film is a positive C-plate.

The second retardation layer may be fabricated by any known process so as to have the above-mentioned retardations. A typical example of the process is explained above in the description regarding the second retardation layer in the first embodiment.

In terms of a reduction in thickness of the liquid crystal display device, the second retardation layer is preferably fabricated by forming an optically anisotropic layer containing a liquid crystalline compound. The second retardation layer should preferably include an optically anisotropic layer containing a liquid crystalline compound to achieve a thickness of approximately 0.3 to 2.5 μm.

The third retardation layer is disposed between the fourth retardation layer and the liquid crystal layer. The absolute value of the retardation Re (550) of the third retardation layer is 10 nm or less, while the retardation Rth (550) of the third retardation layer is 400 to 500 nm. The third retardation layer functions as a compensator for the liquid crystal layer in cooperation with the second retardation layer. It is therefore preferred that the third retardation layer and the liquid crystal layer retain no retardation layer therebetween.

The retardation Rth (550) of the third retardation layer is preferably 410 to 490 nm, and more preferably 420 to 480 nm.

The absolute value of the retardation Re (550) of the third retardation layer is preferably 5 nm or less, and more preferably substantially 0 nm. A typical example of such a film is a negative C-plate.

In the liquid crystal display device according to the fourth embodiment, the difference in the retardation Re (550) between the second retardation layer and the third retardation layer should preferably be small. The difference in the absolute value of the retardation Re (550) between the second retardation layer and the third retardation layer is 10 nm or less, preferably 5 nm or less, and more preferably substantially 0 nm.

The third retardation layer may be fabricated by any known process so as to have the above-mentioned retardations. A typical example of the process is explained above in the description regarding the third retardation layer in the first embodiment.

In terms of a reduction in thickness of the liquid crystal display device, the third retardation layer is preferably fabricated by forming an optically anisotropic layer containing a liquid crystalline compound. The third retardation layer should preferably include an optically anisotropic layer containing a liquid crystalline compound to achieve a thickness of approximately 3.0 to 6.0 μm.

The liquid crystal display device according to the fourth embodiment further includes a fifth retardation layer 8. The details of the fifth retardation layer and its preferred numeric ranges are described above in the first embodiment.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows. Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (21) and (22):

$$Re ( θ ) = [ nx - \frac{( ny \times nz )}{( \sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} )} ] \times \frac{d}{cos \{ {sin}^{- 1} ( \frac{sin ( - θ )}{nx} ) \}} \qquad ( 21 )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (21):

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

The instrument KOBRA-21ADH or KOBRA-WR calculates nx, ny, and nz, through input of the assumed average refractive index and the film thickness, and then calculates Nz=(nx−nz)/(nx−ny) on the basis of the calculated nx, ny, and nz.

Throughout the specification, the wavelength for measurement of the retardations Re and Rth is 550 nm, unless otherwise stated. The conditions for the measurement are a temperature of 25° C. and a relative humidity (RH) of 60%, unless otherwise stated.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### <Fabrication of Cellulose Acylate Film 001>

### <<Preparation of Cellulose Acylate>>

Cellulose acylate having a total degree of substitution of 2.97 (degree of acetyl substitution: 0.45, and degree of propionyl substitution: 2.52) was prepared. The mixture of sulfuric acid (7.8 parts by mass) as a catalyst and a dicarboxylic anhydride was cooled to −20° C., and then added to cellulose (100 parts by mass) derived from pulp. The cellulose was acylated at 40° C. The type and amount of the dicarboxylic anhydride were adjusted to control the type and degree of substitution of acyl groups. The total degree of substitution was further adjusted by aging at 40° C. after the acylation.

### <<Preparation of Cellulose Acylate Solution>>

### 1) Cellulose Acylate

The prepared cellulose acylate was heated to 120° C. and dried to decrease a moisture content up to 0.5% by mass or lower. The cellulose acylate (30 parts by mass) was then mixed with solvents.

### 2) Solvents

The solvents used were dichloromethane, methanol, and butanol (81, 15, and 4 parts by mass, respectively). The solvents each had a moisture content of 0.2% by mass or lower.

### 3) Additives

Trimethylolpropane triacetate (0.9 part by mass) and fine silicon-dioxide particles having a diameter of 20 nm (approximately 0.25 parts by mass) were added to each solution preparation.

A UV absorbent A (1.2% by mass) and an Rth reducer B (11% by mass), which each is represented by the formulae below, were added to the cellulose acylate (100 parts by mass).

The resulting cellulose acylate film 001 had a retardation Re (550) of −1 nm and a retardation Rth (550) of −1 nm, and was optically isotropic.

UV absorbent A

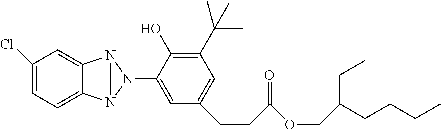 [SMILES: CCCCC(CC)COC(=O)CCc1cc(-n2n3c4ccc(Cl)cc4n23)c(O)c(C(C)(C)C)c1]

Rth reducer B

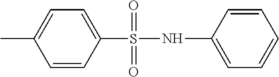 [SMILES: Cc1ccc(S(=O)(=O)Nc2ccccc2)cc1]

### 4) Swelling and Dissolution

The solvents and additives were introduced into a stainless steel tank provided with stirring blades while cooling water was being circulated therearound. The cellulose acylate was gradually added into the tank while its content was being stirred for dispersion. After completion of the addition, the content was stirred at a room temperature for two hours, was swelled for three hours, and then was stirred again. This process produced a cellulose acylate solution.

The stirring was performed with a dissolver-type eccentric stirring rod for stirring at a rim speed of 15 m/sec (shear stress of 5×10⁴ kgf/m/sec²), and a stirring rod including an anchor blade at the central axis for stirring at a rim speed of 1 m/sec (shear stress of 1×10⁴ kgf/m/sec²). During the swelling process, the faster stirring rod was stopped while the stirring rod including the anchor blade was being operated at a rim speed of 0.5 m/sec.

### 5) Filtration

The resulting cellulose acylate solution was filtered through a filter paper #63 (manufactured by Toyo Roshi Kaisha, Ltd.) having an absolute filtration accuracy of 0.01 mm, and then filtered through a filter paper FH025 (manufactured by Pall Corporation) having an absolute filtration accuracy of 2.5 μm.

### <<Fabrication of Cellulose Acylate Film>>

The filtered cellulose acylate solution was warmed to 30° C., and was cast on a mirror-finished stainless steel support having a band length of 60 m and kept at 15° C. with a casting T-die (disclosed in Japanese Unexamined Patent Application Publication No. H11-314233). The casting rate was 15 m/min, and the coating width was 200 cm. The temperature of the space encompassing the entire casting portion was 15° C. The cellulose acylate film after casting and spinning was removed from the band at a position 50 cm before the casting portion, and exposed to a 45° C. dry air stream. After drying at 110° C. for five minutes and then 140° C. for ten minutes, a cellulose acylate film 001 having a thickness of 81 μm was prepared. The resulting cellulose acylate film had a retardation Re of −1 nm and a retardation Rth of −1 nm.

### Process 1: Fabrication of First and Fourth Retardation Layers According to Third and Fourth Embodiments

A film for each of the first and fourth retardation layers incorporated in the liquid crystal display device including a liquid crystal layer having two domains (2D) in the examples and comparative examples, was fabricated by the following process.

### <<Alkali Saponification>>

The cellulose acylate film 001 was conveyed through a dielectric heating roller set at 60° C., to raise the film-surface temperature to 40° C. An alkaline solution having a composition shown below was applied onto one surface of the film into a density of 14 ml/m² with a bar coater. The film was conveyed through a steamed far-infrared heater (manufactured by NORITAKE CO., LIMITED) kept at 110° C. for ten seconds. The film was then coated with pure water into a density of 3 ml/m² using the bar coater. After three cycles of a washing process using a fountain coater and a drainage process using an air knife, the film was conveyed for drying through a drying area at 70° C. for ten seconds. This process yielded an alkali-saponified cellulose acylate film.

### Composition of the Alkaline Solution

| | | |
|---|---|---|
| Potassium hydroxide | 4.7 | parts by mass |
| Water | 15.8 | parts by mass |
| Isopropyl alcohol | 63.7 | parts by mass |
| Surfactant SF-1: C₁₄H₂₉O (CH₂CH₂O)₂₀H | 1.0 | part by mass |
| Propylene glycol | 14.8 | parts by mass |

### <<Formation of Alignment Film>>

The long cellulose acetate film after saponification was continuously coated with an alignment-film coating solution having a composition shown below with a wire bar #14. The film was dried in a 60° C. warm air stream for 60 seconds, and then in a 100° C. warm air stream for 120 seconds.

### Composition of the Alignment-Film Coating Solution

| | | |
|---|---|---|
| Modified poly (vinyl alcohol) (below) | 10 | parts by mass |
| Water | 371 | parts by mass |
| Methanol | 119 | parts by mass |
| Glutaraldehyde | 0.5 | part by mass |
| Photopolymerization initiator | 0.3 | part by mass |

(Irgacure-2959 manufactured by BASF)

### Modified Poly(Vinyl Alcohol)

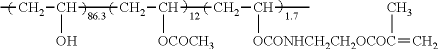

### <<Fabrication of Optically Anisotropic Layer Containing Discotic Liquid Crystalline Compound>>

The resulting alignment film was continuously rubbed. The long film was conveyed along its longitudinal direction. The rotation axis of a rubbing roller was directed to 45° clockwise to the longitudinal direction of the film.

A coating solution (A) containing a discotic liquid crystalline compound (having a composition shown below) was applied onto the resulting alignment film with a wire bar. The film was heated in an 80° C. warm air stream for 90 seconds, for evaporating the solvents in the coating solution and for aging the alignment of the discotic liquid crystal molecules. The film was irradiated with ultraviolet rays at 80° C., to stabilize the alignment of the liquid crystal molecules and form an optically anisotropic layer. This process yielded a desired optical film. The thickness of the optically anisotropic layer was 2.0 μm.

### Composition of the Coating Solution (A) for an Optically Anisotropic Layer

| Discotic liquid crystalline compound (below) | 100 | parts by mass |
|---|---|---|
| Photopolymerization initiator | 3 | parts by mass |
| (Irgacure-907 manufactured by BASF) | | |
| Sensitizer (Kayacure-DETX manufactured | 1 | part by mass |
| by Nippon Kayaku Co., Ltd.) | | |
| Pyridinium salt (below) | 1 | part by mass |
| Fluorine polymer FP1 (below) | 0.4 | part by mass |
| Methyl ethyl ketone | 252 | parts by mass |

### Discotic Liquid Crystalline Compound

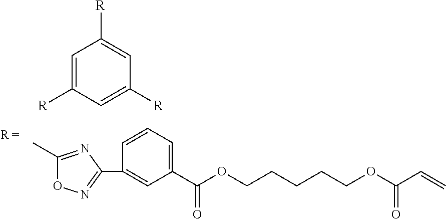

### Pyridinium Salt

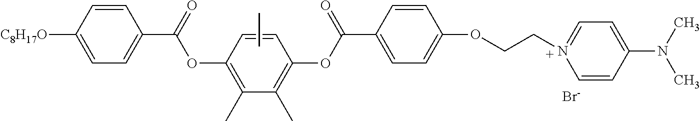

### Fluorine Polymer FP1

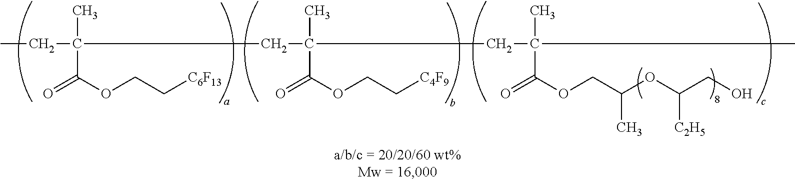

The results of evaluation of the optical films are shown below. The slow axis was parallel to the rotation axis of the rubbing roller. That is, the slow axis was directed to 45° clockwise to the longitudinal direction of the support. The thickness of the optically anisotropic layer was adjusted such that the films for the first and fourth retardation layers had retardations Re (550) and Rth (550) shown in the tables below.

### <Process 2: Fabrication of Second Retardation Layer (Film Having Discotic Liquid Crystalline Compound Layer)>

A film for the second retardation layer incorporated in the examples and comparative examples of the present invention was fabricated by the following process.

The resulting cellulose acylate film 001 was alkali-saponified, as in the fabrication of the first and fourth retardation layers.

### <<Formation of Alignment Film>>

An optically anisotropic layer having an adjusted thickness was laminated onto the cellulose acylate film 001, to fabricate a film for the second retardation layer, with reference to a technique disclosed in the examples of Japanese Unexamined Patent Application Publication No. 2008-40309.

### <<Fabrication of Optically Anisotropic Layer Containing Discotic Liquid Crystalline Compound>>

The resulting alignment film was continuously rubbed. The long film was conveyed along its longitudinal direction. The rotation axis of a rubbing roller was directed to 0° clockwise to the longitudinal direction of the film.

A coating solution (C) containing a discotic liquid crystalline compound (having a composition shown below) was continuously applied on the alignment film with a wire bar #2.7. The conveyance velocity (V) of the film was 36 m/min. The film was heated in a 100° C. warm air stream for 30 seconds and then in a 120° C. warm air stream for 90 seconds, for evaporating the solvents in the coating solution and for aging the alignment of the discotic liquid crystal molecules. The film was irradiated with ultraviolet rays at 80° C., to stabilize the alignment of the liquid crystal molecules and form an optically anisotropic layer. This process produced a desired optical film (negative C-plate). The retardations Re and Rth of the film were measured.

### Composition of the Coating Solution (C) for an Optically Anisotropic Layer

| Discotic liquid crystalline compound (below) | 91 | parts by mass |
|---|---|---|
| Ethylene oxide modified trimethylolpropane | 9 | parts by mass |
| triacrylate (V#360 manufactured by Osaka | | |
| Organic Chemical Industry Ltd.) | | |
| Photopolymerization initiator | 3 | parts by mass |
| (Irgacure-907 manufactured by BASF) | | |
| Sensitizer (Kayacure-DETX manufactured | 1 | part by mass |
| by Nippon Kayaku Co., Ltd.) | | |
| Methyl ethyl ketone | 195 | parts by mass |

### Discotic Liquid Crystalline Compound

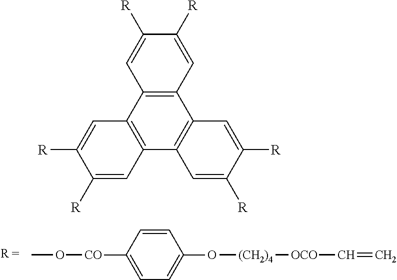

The thickness of the optically anisotropic layer was adjusted such that the film for each second retardation layer had a retardation Rth (550) shown in the tables below.

### <Process 3: Fabrication of Third Retardation Layer>

With reference to Japanese Patent No. 5036209, rod-like liquid crystal molecules are aligned on the resulting cellulose acylate film 001 such that the direction providing a maximum refractive index is substantially perpendicular to the normal direction of the film. The thickness of the film was adjusted such that the film had a retardation Rth disclosed in each of the examples.

### Process 4: Fabrication of First and Fourth Retardation Layers (Film Having Rod-Like Liquid Crystalline Compound Layer) According to First and Second Embodiments

A film for each of the first and fourth retardation layers incorporated in the liquid crystal display device including a liquid crystal layer having two domains (2D) in the examples and comparative examples was fabricated by the following process.

An alkaline solution was applied onto one surface of the resulting cellulose acylate film 001 for saponification. The film was then coated with an alignment-film coating solution (having a composition shown below) into a density of 20 ml/m² with a wire bar coater. After the film was dried in a 60° C. warm air stream for 60 seconds and then in a 100° C. warm air stream for 120 seconds, a precursor of an alignment film was prepared. The alignment film was completed by a rubbing treatment along the direction of 45° relative to the longitudinal direction of the cellulose acylate film 001.

Composition of the alignment-film coating solution

| | | |
|---|---|---|
| Modified poly (vinyl alcohol) (below) | 10 | parts by mass |
| Water | 371 | parts by mass |
| Methanol | 119 | parts by mass |
| Glutaraldehyde | 0.5 | part by mass |

### Modified Poly(Vinyl Alcohol)

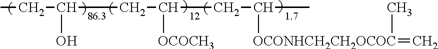

A coating solution for an optically anisotropic layer (having a composition shown below) was then applied with a wire bar.

| | | |
|---|---|---|
| Rod-like liquid crystalline | 1.8 | g |
| compound (below) | | |
| Ethylene oxide modified | 0.2 | g |
| trimethylolpropane triacrylate (V#360 | | |
| manufactured by Osaka Organic Chemical Industry Ltd.) | | |
| Photopolymerization initiator | 0.06 | g |
| (Irgacure-907 manufactured byBASF) | | |
| Sensitizer (Kayacure-DETX | 0.02 | g |
| manufactured by Nippon Kayaku Co., Ltd.) | | |
| Methyl ethyl ketone | 3.9 | g |

The resulting film was heated in a thermostatic chamber kept at 125° C. for three minutes, to align rod-like liquid crystal molecules. The film was then irradiated with ultraviolet rays for 30 seconds with a high-pressure mercury-vapor lamp having an output of 120 W/cm, to crosslink the rod-like liquid crystal molecules. The temperature during the ultraviolet curing was 80° C. An optically anisotropic layer having a thickness of 2.0 μm was thereby prepared. The film was allowed to stand to cool to room temperature. This process produced a desired optical film (positive A-plate). Rod-like liquid crystalline compound

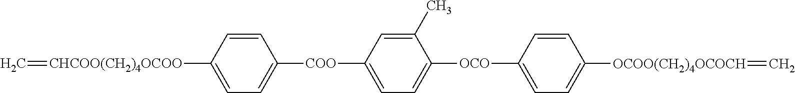

The thickness of the optically anisotropic layer was adjusted such that the films for the individual first and fourth retardation layers had retardations Re (550) and Rth (550) shown in the tables below.

### <Process 5: Fabrication of Fourth Retardation Layer (Patterned Retarder)>

A film for the fourth retardation layer incorporated in the liquid crystal display device including a liquid crystal layer having four domains (4D) in the examples and comparative examples, was fabricated by the following process.

### <<Alkali Saponification>>

The cellulose acylate film 001 was conveyed through a dielectric heating roller set at 60° C., to raise the surface temperature of the film to 40° C. An alkaline solution having a composition shown below was applied onto one surface of the film into a density of 14 ml/m² with a bar coater. The film was conveyed through a steamed far-infrared heater (manufactured by NORITAKE CO., LIMITED) kept at 110° C. for ten seconds. The film was then coated with pure water into a density of 3 ml/m² with the bar coater. After three cycles of a washing process using a fountain coater and a drainage process using an air knife, the film was conveyed for drying through a drying area at 70° C. for ten seconds. This process yielded an alkali-saponified cellulose-acetate transparent support.

### Composition of the Alkaline Solution

| | | |
|---|---|---|
| Potassium hydroxide | 4.7 | parts by mass |
| Water | 15.8 | parts by mass |
| Isopropyl alcohol | 63.7 | parts by mass |
| Surfactant | 1.0 | part by mass |
| SF-1: C₁₄H₂₉O(CH₂CH₂O)₂₀H | | |
| Propylene glycol | 14.8 | parts by mass |

### <<Formation of Rubbed Alignment Film>>

The saponified surface of the resulting support was continuously coated with a coating solution for a rubbed alignment-film (having a composition shown below) with a wire bar #8. After the coating layer was dried in a 60° C. warm air stream for 60 seconds and then in a 100° C. warm air stream for 120 seconds, a rubbed alignment film was prepared. A striped mask (the width of each horizontal stripe was 100 μm in light-transmissive portions, and 300 μm in light-shielding portions) was disposed on the rubbed alignment film. The film was irradiated with ultraviolet rays in air at room temperature for four seconds, with an air-cooled metal halide lamp (manufactured by EYE GRAPHICS CO., LTD.) having a luminance of 2.5 mW/cm² in the UV-C band, so that a photo-acid generator was decomposed to acid. This process yielded regions in the alignment film for the first retardation areas. After a single reciprocation of a rubbing treatment at 500 rpm along one direction, the transparent support provided with the rubbed alignment film was prepared. The thickness of the alignment film was 0.5 μm.

### Composition of the Coating Solution for an Alignment Film

| Polymer material for an alignment film | 3.9 | parts by mass |
|---|---|---|
| (poly (vinyl alcohol) PVA103 manufactured | | |
| by KURARAY CO., LTD.) | | |
| Photo-acid generator S-2 | 0.1 | part by mass |
| Methanol | 36 | parts by mass |
| Water | 60 | parts by mass |

### Photo-acid Generator S-2

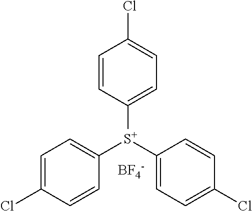

### <<Formation of Patterned Optically Anisotropic Layer>>

A composition for an optically anisotropic layer (having a composition shown below) was prepared, and was filtered through a polypropylene filter having a pore diameter of 0.2 μm, to yield a coating solution for an optically anisotropic layer. The solution was applied onto the support into a density of 8 ml/m² with a bar coater. The support was dried at a film-surface temperature of 110° C. for two minutes, to form a liquid crystalline phase and to achieve a uniform alignment. The support was then cooled to 100° C., and was irradiated with ultraviolet rays in air for 20 seconds, with an air-cooled metal halide lamp (manufactured by EYE GRAPHICS CO., LTD.) having a luminance of 20 mW/cm², to stabilize the alignment state. This process produced a patterned optically anisotropic layer. The discotic liquid crystal (DLC) molecules were vertically aligned, such that the slow-axis direction was parallel to the rubbing direction in areas exposed from the mask (first retardation areas) while the directions were orthogonal to each other in unexposed areas (second retardation areas). The thickness of the optically anisotropic layer was 1.6 μm.

### Composition for an Optically Anisotropic Layer

| Discotic liquid crystal E-1 | 100 | parts by mass |
|---|---|---|
| Alignment agent for alignment-film interface (II-1) | 3.0 | parts by mass |
| Alignment agent for air interface (P-1) | 0.4 | part by mass |
| Photopolymerization initiator | 3.0 | parts by mass |
| (Irgacure-907 manufactured by BASF) | | |
| Sensitizer (Kayacure-DETX manufactured | 1.0 | part by mass |
| by Nippon Kayaku Co., Ltd.) | | |
| Methyl ethyl ketone | 400 | parts by mass |

### Discotic Liquid Crystal E-1

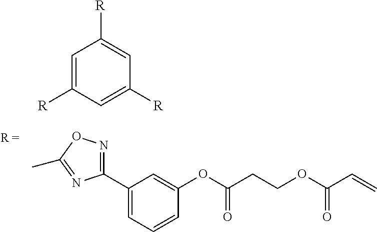

### Alignment Agent for Alignment-film Interface (II-1)

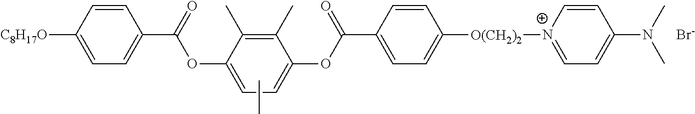

### Alignment Agent for Air Iinterface (P-1)

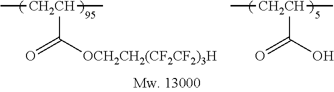

The first and second retardation areas of the resulting patterned optical film were analyzed by a time-of-flight secondary ion mass spectrometry (TOF-SIMS V provided by ION-TOF). The molar ratio in the first retardation area to the second retardation area of the photo-acid generator S-2 in the alignment film was 8 to 92. The results indicate that most of the photo-acid generator S-2 was decomposed in the first retardation area. Cations from the agent II-1 and anions BF₄⁻ from the acid HBF₄ generated by the photo-acid generator S-2 were observed at the air interface of the first retardation area in the optically anisotropic layer. In contrast, in the second retardation area, these ions were scarcely observed at the air interface, while cations from the agent II-1 and anions Br⁻ were observed near the alignment-film interface. The ratio of the cations from the agent II-1 was 93 to 7, and that of the anions BF₄⁻ was 90 to 10, at the air interfaces of the retardation areas. That is, the alignment agent for alignment-film interface II-1 was concentrated near the alignment-film interface in the second retardation area, while the agent II-1 was more evenly distributed and diffused to the air interface in the first retardation area. In addition, anion exchange between the generated acid HBF₄ and the agent II-1 promoted the diffusion of the cations from the agent II-1 across the first retardation area.

The thickness of the optically anisotropic layer was adjusted such that the film for each fourth retardation layer had retardations Re (550) and Rth (550) shown in the tables below.

### <Process 6: Fabrication of First Retardation Layer (Patterned Retarder)>

A film for the first retardation layer incorporated in the liquid crystal display device including a liquid crystal layer having two domains (2D) in the examples and comparative examples was fabricated by the following process.

An alignment film was formed as in the fabrication of the fourth retardation layer (patterned retarder). One surface of the alignment film was coated with an optically anisotropic layer such that LC242 (rod-like liquid crystal (RLC) manufactured by BASF) contained therein defines the first and second retardation areas, by a technique disclosed in the examples of Published Japanese Translation of PCT International Patent Publication No. 2012-517024.

The thickness of the optically anisotropic layer was adjusted such that the film for each first retardation layer had retardations Re (550) and Rth (550) shown in the tables below.

### <Fabrication of Fifth Retardation Layer (Optical Compensation Film)>

The fifth retardation layers shown in the tables were fabricated by a technique disclosed in the examples of Japanese Unexamined Patent Application Publication No. 2012-8548.

### Fabrication of Liquid Crystal Display Device According to First Embodiment

### Examples 1A to 20A and Comparative Examples 1A to 17A

### Polarizing Film

As is disclosed in Example 1 of Japanese Unexamined Patent Application Publication No. 2001-141926, a stretched poly(vinyl alcohol) film was allowed to adsorb iodine, to form a polarizing film having a thickness of 20 μm.

Any one of the first, second, third, fourth, and fifth retardation layers was saponified and laminated onto one surface of the polarizing film with a poly(vinyl alcohol) adhesive, to have a layer configuration illustrated in each of FIG. 3 and the tables below. The resultant was dried at 70° C. for at least ten minutes. A commercially available cellulose acetate film (TD80 manufactured by FUJIFILM Corporation) was saponified and laminated onto the other surface of the polarizing film in the same way. This process yielded a polarizer.

### <<Fabrication of VA-Mode Liquid Crystal Cell>>

The cell gap between the substrates was set at 3.6 μm, was filled with a liquid crystal material having negative dielectric-constant anisotropy (MLC 6608 manufactured by Merck KGaA), and was sealed, to form a liquid crystal layer between the substrates. The thickness d of the liquid crystal layer was adjusted such that the liquid crystal layer had a retardation (i.e., product Δn·d of the refractive-index anisotropy Δn and the thickness d (μm) of the liquid crystal layer) shown in each table below. The liquid crystal molecules were vertically aligned. This process produced a VA-mode liquid crystal cell.

The resulting liquid crystal display device according to Example 19A includes a fifth retardation layer between the second polarizing film and the fourth retardation layer, while the device according to Example 20A lacks a fifth retardation layer.

TABLE 2

| | Example 1A | | | Example 2A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 135 |
| Second polarizing film | — | — | 90 | — | — | 90 |

TABLE 3

| | Example 3A | | | Example 4A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 125 | 62.5 | 45 & 135 | 125 | 62.5 | 45 |
| Second retardation layer | 0 | −150 | — | 0 | −150 | — |
| Liquid crystal layer | 0 | −300 | 4D | 0 | −300 | 2D |
| Third retardation layer | 0 | 350 | — | 0 | 350 | — |
| Fourth retardation layer | 125 | 62.5 | 135 & 45 | 125 | 62.5 | 135 |
| Second polarizing film | — | — | 90 | — | — | 90 |

TABLE 4

| | Example 5A | | | Example 6A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 25 | 12.5 | 45 & 135 | 25 | 12.5 | 45 |
| Second retardation layer | 0 | −150 | — | 0 | −150 | — |
| Liquid crystal layer | 0 | −300 | 4D | 0 | −300 | 2D |
| Third retardation layer | 0 | 350 | — | 0 | 350 | — |
| Fourth retardation layer | 25 | 12.5 | 135 & 45 | 25 | 12.5 | 135 |
| Second polarizing film | — | — | 90 | — | — | 90 |

TABLE 5

| | Example 7A | | | Example 8A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 300 | — | 0 | 300 | — |
| Fourth retardation layer | 75 | 37.5 | 135 & 45 | 75 | 37.5 | 135 |
| Second polarizing film | — | — | 90 | — | — | 90 |

TABLE 6

| | Example 9A | | | Example 10A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 400 | — | 0 | 400 | — |
| Fourth retardation layer | 75 | 37.5 | 135 & 45 | 75 | 37.5 | 135 |
| Second polarizing film | — | — | 90 | — | — | 90 |

TABLE 7

| | Example 11A | | | Example 12A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −200 | — | 0 | −200 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 135 |
| Second polarizing film | — | — | 90 | — | — | 90 |

TABLE 8

| | Example 13A | | | Example 14A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 135 |
| Second polarizing film | — | — | 90 | — | — | 90 |

TABLE 9

| | Example 15A | | | Example 16A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 | 75 | 37.5 | 45 |
| Second retardation layer | 0 | −150 | — | 0 | −150 | — |
| Liquid crystal layer | 0 | −250 | 2D | 0 | −450 | 2D |
| Third retardation layer | 0 | 300 | — | 0 | 300 | — |
| Fourth retardation layer | 75 | 37.5 | 135 | 75 | 37.5 | 135 |
| Second polarizing film | — | — | 90 | — | — | 90 |

TABLE 10

| | Example 17A | | | Example 18A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | — | — | 90 |
| | 0 | −160 | — | — | — | — |
| First retardation layer | 75 | 37.5 | 45 | 75 | 37.5 | 45 |
| Second retardation layer | 0 | −150 | — | 0 | −150 | — |
| Liquid crystal layer | 0 | −300 | 2D | 0 | −300 | 2D |
| Third retardation layer | 0 | 350 | — | 0 | 350 | — |
| Fourth retardation layer | 65 | 32.5 | 135 | 75 | 37.5 | 135 |
| Second polarizing film | — | — | 90 | — | — | 90 |

TABLE 11

| | Example 19A | | |
|---|---|---|---|
| | Optical property | | |
| | | | Slow axis or |
| Layer configuration | Re[nm] | Rth[nm] | Absorption axis |
| First polarizing film | — | — | 0 |
| First retardation layer | 75 | 37.5 | 45 |
| Second retardation layer | 0 | −150 | — |
| Liquid crystal layer | 0 | −300 | 2D |
| Third retardation layer | 0 | 350 | — |
| Fourth retardation layer | 75 | 37.5 | 135 |
| Fifth retardation layer | 0 | −160 | — |
| | 100 | 100 | 0 |
| Second polarizing film | — | — | 90 |

TABLE 12

| | Example 20A | | |
|---|---|---|---|
| | Optical property | | |
| | | | Slow axis or |
| Layer configuration | Re[nm] | Rth[nm] | Absorption axis |
| First polarizing film | — | — | 0 |
| Fifth retardation layer | — | — | — |
| | — | — | — |
| First retardation layer | 75 | 37.5 | 45 |
| Second retardation layer | 0 | −150 | — |
| Liquid crystal layer | 0 | −300 | 2D |
| Third retardation layer | 0 | 350 | — |
| Fourth retardation layer | 75 | 37.5 | 135 |
| Second polarizing film | — | — | 90 |

TABLE 13

| | Comparative Example 1A | | | Comparative Example 2A | | | Comparative Example 3A | | |
|---|---|---|---|---|---|---|---|---|---|
| | Optical property | | | Optical property | | | Optical property | | |
| | | | Slow axis or | | | Slow axis or | | | Slow axis or |
| Layer configuration | Re[nm] | Rth[nm] | Absorption axis | Re[nm] | Rth[nm] | Absorption axis | Re[nm] | Rth[nm] | Absorption axis |
| First polarizing film | — | — | 0 | — | — | 0 | — | — | 0 |
| Fifth retardation layer | 100 | 100 | 90 | 100 | 100 | 90 | 100 | 100 | 90 |
| | 0 | −160 | — | 0 | −160 | — | 0 | −160 | — |
| First retardation layer | — | — | — | — | — | — | — | — | — |
| Second retardation layer | 0 | −100 | — | 0 | −100 | — | 0 | −100 | — |
| Liquid crystal layer | 0 | −300 | 8D | 0 | −300 | 4D | 0 | −300 | 2D |
| Third retardation layer | 0 | 400 | — | 0 | 400 | — | 0 | 400 | — |
| Fourth retardation layer | — | — | — | — | — | — | — | — | — |
| Second polarizing film | — | — | 90 | — | — | 90 | — | — | 90 |

TABLE 14

| | Comparative Example 4A | | | Comparative Example 5A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 145 | 72.5 | 45 & 135 | 145 | 72.5 | 45 |
| Second retardation layer | 0 | −150 | — | 0 | −150 | — |
| Liquid crystal layer | 0 | −300 | 4D | 0 | −300 | 2D |
| Third retardation layer | 0 | 300 | — | 0 | 300 | — |
| Fourth retardation layer | 145 | 72.5 | 135 & 45 | 145 | 72.5 | 135 |
| Second polarizing film | — | — | 90 | — | — | 90 |

TABLE 15

| | Comparative Example 6A | | | Comparative Example 7A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 5 | 2.5 | 45 & 135 | 5 | 2.5 | 45 |
| Second retardation layer | 0 | −150 | — | 0 | −150 | — |
| Liquid crystal layer | 0 | −300 | 4D | 0 | −300 | 2D |
| Third retardation layer | 0 | 300 | — | 0 | 300 | — |
| Fourth retardation layer | 5 | 2.5 | 135 & 45 | 5 | 2.5 | 135 |
| Second polarizing film | — | — | 90 | — | — | 90 |

TABLE 16

| | Comparative Example 8A | | | Comparative Example 9A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 135 |
| Second polarizing film | — | — | 90 | — | — | 90 |

TABLE 17

| | Comparative Example 10A | | | Comparative Example 11A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 250 | — | 0 | 250 | — |
| Fourth retardation layer | 75 | 37.5 | 135 & 45 | 75 | 37.5 | 135 |
| Second polarizing film | — | — | 90 | — | — | 90 |

TABLE 18

| | Comparative Example 12A | | | Comparative Example 1 3A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −250 | — | 0 | −250 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 135 |
| Second polarizing film | — | — | 90 | — | — | 90 |

TABLE 19

| | Comparative Example 14A | | | Comparative Example 15A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 45 |
| Second retardation layer | 0 | −50 | — | 0 | −50 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 135 |
| Second polarizing film | — | — | 90 | — | — | 90 |

TABLE 20

| | Comparative Example 16A | | | Comparative Example 17A | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 | 75 | 37.5 | 45 |
| Second retardation layer | 0 | −150 | — | 0 | −150 | — |
| Liquid crystal layer | 0 | −200 | 2D | 0 | −500 | 2D |
| Third retardation layer | 0 | 350 | — | 0 | 350 | — |
| Fourth retardation layer | 75 | 37.5 | 135 | 75 | 37.5 | 135 |
| Second polarizing film | — | — | 90 | — | — | 90 |

In the above tables, the term “2D” indicates a pixel of the liquid crystal cell having two domains, “4D” indicates a pixel of four domains, and “8D” indicates a pixel of eight domains.

The angles of the slow axes and absorption axes are defined such that the absorption axis of the first polarizing film is 0° and the counterclockwise direction as viewed from a viewer is positive.

### <Fabrication of Liquid Crystal Display Device According to Second Embodiment

### Examples 1B to 20B and Comparative Examples 1B to 17B

The fabrication of the liquid crystal display device according to the second embodiment (Examples 1B to 20B and Comparative Examples 1B to 17B) is identical to that of the first embodiment (Examples 1A to 20A and Comparative Examples 1A to 17A), except for the layer configuration of the retardation layers illustrated in each of FIG. 4 and the tables below.

The resulting liquid crystal display device according to Example 19B includes a fifth retardation layer between the second polarizing film and the fourth retardation layer, while the device according to Example 20B lacks a fifth retardation layer.

TABLE 21

| | Example 1B | | | Example 2B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 45 |
| Second polarizing film | — | — | 90 | — | — | 90 |

TABLE 22

| | Example 3B | | | Example 4B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 125 | 62.5 | 45 & 135 | 125 | 62.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 125 | 62.5 | 135 & 45 | 125 | 62.5 | 45 |
| Second polarizing film | — | — | 90 | — | — | 90 |

TABLE 23

| | Example 5B | | | Example 6B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 25 | 12.5 | 45 & 135 | 25 | 12.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 25 | 12.5 | 135 & 45 | 25 | 12.5 | 45 |
| Second polarizing film | — | — | 90 | — | — | 90 |

TABLE 24

| | Example 7B | | | Example 8B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 135 |
| | 0 | −160 | — | 0 | −160 | — |
| First retardation layer | 75 | 37.5 | 45 & 135 | 75 | 37.5 | 135 |
| Second retardation layer | 0 | −250 | — | 0 | −250 | — |
| Liquid crystal layer | 0 | −300 | 4D | 0 | −300 | 2D |
| Third retardation layer | 0 | 400 | — | 0 | 400 | — |
| Fourth retardation layer | 75 | 37.5 | 135 & 45 | 75 | 37.5 | 45 |
| Second polarizing film | — | — | 90 | — | — | 90 |

TABLE 25

| | Example 9B | | | Example 10B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 135 & 45 | 75 | 37.5 | 135 |
| Second retardation layer | 0 | −250 | — | 0 | −250 | — |
| Liquid crystal layer | 0 | −300 | 4D | 0 | −300 | 2D |
| Third retardation layer | 0 | 500 | — | 0 | 500 | — |
| Fourth retardation layer | 75 | 37.5 | 45 & 135 | 75 | 37.5 | 45 |
| Second polarizing film | — | — | 90 | — | — | 90 |

TABLE 26

| | Example 11B | | | Example 12B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −300 | — | 0 | −300 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 45 |
| Second polarizing film | — | — | 90 | — | — | 90 |

TABLE 27

| | Example 13B | | | Example 14B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −200 | — | 0 | −200 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 45 |
| Second polarizing film | — | — | 90 | — | — | 90 |

TABLE 28

| | Example 15B | | | Example 16B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 135 | 75 | 37.5 | 135 |
| Second retardation layer | 0 | −250 | — | 0 | −250 | — |
| Liquid crystal layer | 0 | −250 | 2D | 0 | −450 | 2D |
| Third retardation layer | 0 | 450 | — | 0 | 450 | — |
| Fourth retardation layer | 75 | 37.5 | 45 | 75 | 37.5 | 45 |
| Second polarizing film | — | — | 90 | — | — | 90 |

TABLE 29

| | Example 17B | | | Example 18B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | — | — | 90 |
| | 0 | −160 | — | — | — | — |
| First retardation layer | 75 | 37.5 | 135 | 75 | 37.5 | 135 |
| Second retardation layer | 0 | −250 | — | 0 | −250 | — |
| Liquid crystal layer | 0 | −300 | 2D | 0 | −300 | 2D |
| Third retardation layer | 0 | 450 | — | 0 | 450 | — |
| Fourth retardation layer | 65 | 32.5 | 45 | 75 | 37.5 | 45 |
| Second polarizing film | — | — | 90 | — | — | 90 |

TABLE 30

| | Example 19B | | |
|---|---|---|---|
| | Optical property | | |
| | | | Slow axis or |
| Layer configuration | Re[nm] | Rth[nm] | Absorption axis |
| First polarizing film | — | — | 0 |
| First retardation layer | 75 | 37.5 | 135 |
| Second retardation layer | 0 | −250 | — |
| Liquid crystal layer | 0 | −300 | 2D |
| Third retardation layer | 0 | 450 | — |
| Fourth retardation layer | 75 | 37.5 | 45 |
| Fifth retardation layer | 0 | −160 | — |
| | 100 | 100 | 0 |
| Second polarizing film | — | — | 90 |

TABLE 31

| | Example 20B | | |
|---|---|---|---|
| | Optical property | | |
| | | | Slow axis or |
| Layer configuration | Re[nm] | Rth[nm] | Absorption axis |
| First polarizing film | — | — | 0 |
| Fifth retardation layer | — | — | — |
| | — | — | — |
| First retardation layer | 75 | 37.5 | 135 |
| Second retardation layer | 0 | −250 | — |
| Liquid crystal layer | 0 | −300 | 2D |
| Third retardation layer | 0 | 450 | — |
| Fourth retardation layer | 75 | 37.5 | 45 |
| Second polarizing film | — | — | 90 |

TABLE 32

| | Comparative Example 1B | | | Comparative Example 2B | | | Comparative Example 3B | | |
|---|---|---|---|---|---|---|---|---|---|
| | Optical property | | | Optical property | | | Optical property | | |
| | | | Slow axis or | | | Slow axis or | | | Slow axis or |
| Layer configuration | Re[nm] | Rth[nm] | Absorption axis | Re[nm] | Rth[nm] | Absorption axis | Re[nm] | Rth[nm] | Absorption axis |
| First polarizing film | — | — | 0 | — | — | 0 | — | — | 0 |
| Fifth retardation layer | 100 | 100 | 90 | 100 | 100 | 90 | 100 | 100 | 90 |
| | 0 | −160 | — | 0 | −160 | — | 0 | −160 | — |
| First retardation layer | — | — | — | — | — | — | — | — | — |
| Second retardation layer | 0 | −150 | — | 0 | −150 | — | 0 | −150 | — |
| Liquid crystal layer | 0 | −300 | 8D | 0 | −300 | 4D | 0 | −300 | 2D |
| Third retardation layer | 0 | 450 | — | 0 | 450 | — | 0 | 450 | — |
| Fourth retardation layer | — | — | — | — | — | — | — | — | — |
| Second polarizing film | — | — | 90 | — | — | 90 | — | — | 90 |

TABLE 33

| | Comparative Example 4B | | | Comparative Example 5B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 145 | 72.5 | 45 & 135 | 145 | 72.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 145 | 72.5 | 135 & 45 | 145 | 72.5 | 45 |
| Second polarizing film | — | — | 90 | — | — | 90 |

TABLE 34

| | Comparative Example 6B | | | Comparative Example 7B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 5 | 2.5 | 45 & 135 | 5 | 2.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 5 | 2.5 | 135 & 45 | 5 | 2.5 | 45 |
| Second polarizing film | — | — | 90 | — | — | 90 |

TABLE 35

| | Comparative Example 8B | | | Comparative Example 9B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 550 | — | 0 | 550 | — |
| Fourth retardation layer | 75 | 37.5 | 135 & 45 | 75 | 37.5 | 45 |
| Second polarizing film | — | — | 90 | — | — | 90 |

TABLE 36

| | Comparative Example 10B | | | Comparative Example 11B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 350 | — | 0 | 350 | — |
| Fourth retardation layer | 75 | 37.5 | 135 & 45 | 75 | 37.5 | 45 |
| Second polarizing film | — | — | 90 | — | — | 90 |

TABLE 37

| | Comparative Example 12B | | | Comparative Example 13B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −350 | — | 0 | −350 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 45 |
| Second polarizing film | — | — | 90 | — | — | 90 |

TABLE 38

| | Comparative Example 14B | | | Comparative Example 15B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 45 & 135 | 75 | 37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 75 | 37.5 | 135 & 45 | 75 | 37.5 | 45 |
| Second polarizing film | — | — | 90 | — | — | 90 |

TABLE 39

| | Comparative Example 16B | | | Comparative Example 17B | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | 37.5 | 135 | 75 | 37.5 | 135 |
| Second retardation layer | 0 | −250 | — | 0 | −250 | — |
| Liquid crystal layer | 0 | −200 | 2D | 0 | −500 | 2D |
| Third retardation layer | 0 | 450 | — | 0 | 450 | — |
| Fourth retardation layer | 75 | 37.5 | 45 | 75 | 37.5 | 45 |
| Second polarizing film | — | — | 90 | — | — | 90 |

In the above tables, the term “2D” indicates a pixel of the liquid crystal cell having two domains, “4D” indicates a pixel of four domains, and “8D” indicates a pixel of eight domains.

The angles of the slow axes and absorption axes are defined such that the absorption axis of the first polarizing film is 0° and the counterclockwise direction as viewed from a viewer is positive.

### Fabrication of Liquid Crystal Display Device According to Third Embodiment

### Examples 1C to 20C and Comparative Examples 1C to 17C

The fabrication of the liquid crystal display device according to the third embodiment (Examples 1C to 20C and Comparative Examples 1C to 17C) is identical to that of the first embodiment (Examples 1A to 20A and Comparative Examples 1A to 17A), except for the layer configuration of the retardation layers illustrated in each of FIG. 3 and the tables below.

The resulting liquid crystal display device according to Example 19C includes a fifth retardation layer between the second polarizing film and the fourth retardation layer, while the device according to Example 20C lacks a fifth retardation layer.

TABLE 40

| | Example 1C | | | Example 2C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 135 |
| Second polarizing film | — | — | 90 | — | — | 90 |

TABLE 41

| | Example 3C | | | Example 4C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 125 | −62.5 | 45 & 135 | 125 | −62.5 | 45 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 125 | −62.5 | 135 & 45 | 125 | −62.5 | 135 |
| Second polarizing film | — | — | 90 | — | — | 90 |

TABLE 42

| | Example 5C | | | Example 6C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 25 | −12.5 | 45 & 135 | 25 | −12.5 | 45 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 25 | −12.5 | 135 & 45 | 25 | −12.5 | 135 |
| Second polarizing film | — | — | 90 | — | — | 90 |

TABLE 43

| | Example 7C | | | Example 8C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 400 | — | 0 | 400 | — |
| Fourth retardation layer | 75 | −37.5 | 135 & 45 | 75 | −37.5 | 135 |
| Second polarizing film | — | — | 90 | — | — | 90 |

TABLE 44

| | Example 9C | | | Example 10C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 500 | — | 0 | 500 | — |
| Fourth retardation layer | 75 | −37.5 | 135 & 45 | 75 | −37.5 | 135 |
| Second polarizing film | — | — | 90 | — | — | 90 |

TABLE 45

| | Example 11C | | | Example 12C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 135 |
| Second polarizing film | — | — | 90 | — | — | 90 |

TABLE 46

| | Example 13C | | | Example 14C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −50 | — | 0 | −50 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 135 |
| Second polarizing film | — | — | 90 | — | — | 90 |

TABLE 47

| | Example 15C | | | Example 16C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 | 75 | −37.5 | 45 |
| Second retardation layer | 0 | −100 | — | 0 | −100 | — |
| Liquid crystal layer | 0 | −250 | 2D | 0 | −450 | 2D |
| Third retardation layer | 0 | 450 | — | 0 | 450 | — |
| Fourth retardation layer | 75 | −37.5 | 135 | 75 | −37.5 | 135 |
| Second polarizing film | — | — | 90 | — | — | 90 |

TABLE 48

| | Example 17C | | | Example 18C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | — | — | 90 |
| | 0 | −160 | — | — | — | — |
| First retardation layer | 75 | −37.5 | 45 | 75 | −37.5 | 45 |
| Second retardation layer | 0 | −100 | — | 0 | −100 | — |
| Liquid crystal layer | 0 | −300 | 2D | 0 | −300 | 2D |
| Third retardation layer | 0 | 450 | — | 0 | 450 | — |
| Fourth retardation layer | 65 | −32.5 | 135 | 75 | −37.5 | 135 |
| Second polarizing film | — | — | 90 | — | — | 90 |

TABLE 49

| | Example 19C | | |
|---|---|---|---|
| | Optical property | | |
| | | | Slow axis |
| Layer configuration | Re[nm] | Rth[nm] | or Absorption axis |
| First polarizing film | — | — | 0 |
| First retardation layer | 75 | −37.5 | 45 |
| Second retardation layer | 0 | −100 | — |
| Liquid crystal layer | 0 | −300 | 2D |
| Third retardation layer | 0 | 450 | — |
| Fourth retardation layer | 75 | −37.5 | 135 |
| Fifth retardation layer | 0 | −160 | — |
| | 100 | 100 | 0 |
| Second polarizing film | — | — | 90 |

TABLE 50

| | Example 20C | | |
|---|---|---|---|
| | Optical property | | |
| | | | Slow axis |
| Layer configuration | Re[nm] | Rth[nm] | or Absorption axis |
| First polarizing film | — | — | 0 |
| Fifth retardation layer | — | — | — |
| | — | — | — |
| First retardation layer | 75 | −37.5 | 45 |
| Second retardation layer | 0 | −100 | — |
| Liquid crystal layer | 0 | −300 | 2D |
| Third retardation layer | 0 | 450 | — |
| Fourth retardation layer | 75 | −37.5 | 135 |
| Second polarizing film | — | — | 90 |

TABLE 51

| | Comparative Example 1C | | | Comparative Example 2C | | | Comparative Example 3C | | |
|---|---|---|---|---|---|---|---|---|---|
| | Optical property | | | Optical property | | | Optical property | | |
| | | | Slow axis or | | | Slow axis or | | | Slow axis or |
| Layer configuration | Re[nm] | Rth[nm] | Absorption axis | Re[nm] | Rth[nm] | Absorption axis | Re[nm] | Rth[nm] | Absorption axis |
| First polarizing film | — | — | 0 | — | — | 0 | — | — | 0 |
| Fifth retardation layer | 100 | 100 | 90 | 100 | 100 | 90 | 100 | 100 | 90 |
| | 0 | −160 | — | 0 | −160 | — | 0 | −160 | — |
| First retardation layer | — | — | — | — | — | — | — | — | — |
| Second retardation layer | 0 | −100 | — | 0 | −100 | — | 0 | −100 | — |
| Liquid crystal layer | 0 | −300 | 8D | 0 | −300 | 4D | 0 | −300 | 2D |
| Third retardation layer | 0 | 450 | — | 0 | 450 | — | 0 | 450 | — |
| Fourth retardation layer | — | — | — | — | — | — | — | — | — |
| Second polarizing film | — | — | 90 | — | — | 90 | — | — | 90 |

TABLE 52

| | Comparative Example 4C | | | Comparative Example 5C | | |
|---|---|---|---|---|---|---|
| | Optical property | | | Optical property | | |
| | | Rth[nm] Slow axis or | | | | Slow axis or |
| Layer configuration | Re[nm] | Absorption axis | | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 145 | −72.5 | 45 & 135 | 145 | −72.5 | 45 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 145 | −72.5 | 135 & 45 | 145 | −72.5 | 135 |
| Second polarizing film | — | — | 90 | — | — | 90 |

TABLE 53

| | Comparative Example 6C | | | Comparative Example 7C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 5 | −2.5 | 45 & 135 | 5 | −2.5 | 45 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 5 | −2.5 | 135 & 45 | 5 | −2.5 | 135 |
| Second polarizing film | — | — | 90 | — | — | 90 |

TABLE 54

| | Comparative Example 8C | | | Comparative Example 9C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 550 | — | 0 | 550 | — |
| Fourth retardation layer | 75 | −37.5 | 135 & 45 | 75 | −37.5 | 135 |
| Second polarizing film | — | — | 90 | — | — | 90 |

TABLE 55

| | Comparative Example 10C | | | Comparative Example 11C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −100 | — | 0 | −100 | — |
| Liquid crystal layer | 0 | −300 | 4D | 0 | −300 | 2D |
| Third retardation layer | 0 | 350 | — | 0 | 350 | — |
| Fourth retardation layer | 75 | −37.5 | 135 & 45 | 75 | −37.5 | 135 |
| Second polarizing film | — | — | 90 | — | — | 90 |

TABLE 56

| | Comparative Example 12C | | | Comparative Example 13C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | −200 | — | 0 | −200 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 135 |
| Second polarizing film | — | — | 90 | — | — | 90 |

TABLE 57

| | Comparative Example 14C | | | Comparative Example 15C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 45 |
| Second retardation layer | 0 | 0 | — | 0 | 0 | — |
| Liquid crystal layer | 0 | −300 | 4D | 0 | −300 | 2D |
| Third retardation layer | 0 | 350 | — | 0 | 350 | — |
| Fourth retardation layer | 75 | −37.5 | 135 & 45 | 75 | −37.5 | 135 |
| Second polarizing film | — | — | 90 | — | — | 90 |

TABLE 58

| | Comparative Example 16C | | | Comparative Example 17C | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 | 75 | −37.5 | 45 |
| Second retardation layer | 0 | −100 | — | 0 | −100 | — |
| Liquid crystal layer | 0 | −200 | 2D | 0 | −500 | 2D |
| Third retardation layer | 0 | 450 | — | 0 | 450 | — |
| Fourth retardation layer | 75 | −37.5 | 135 | 75 | −37.5 | 135 |
| Second polarizing film | — | — | 90 | — | — | 90 |

In the above tables, the term “2D” indicates a pixel of the liquid crystal cell having two domains, “4D” indicates a pixel of four domains, and “8D” indicates a pixel of eight domains.

The angles of the slow axes and absorption axes are defined such that the absorption axis of the first polarizing film is 0° and the counterclockwise direction as viewed from a viewer is positive.

### Fabrication of Liquid Crystal Display Device According to Fourth Embodiment

### Examples 1D to 20D and Comparative Examples 1D to 17D

The fabrication of the liquid crystal display device according to the fourth embodiment (Examples 1D to 20D and Comparative Examples 1D to 17D) is identical to that of the first embodiment (Examples 1A to 20A and Comparative Examples 1A to 17A), except for the layer configuration of the retardation layers illustrated in each of FIG. 4 and the tables below.

The resulting liquid crystal display device according to Example 19D includes a fifth retardation layer between the second polarizing film and the fourth retardation layer, while the device according to Example 20D lacks a fifth retardation layer.

TABLE 59

| | Example 1D | | | Example 2D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 45 |
| Second polarizing film | — | — | 90 | — | — | 90 |

TABLE 60

| | Example 3D | | | Example 4D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 125 | −62.5 | 45 & 135 | 125 | −62.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 125 | −62.5 | 135 & 45 | 125 | −62.5 | 45 |
| Second polarizing film | — | — | 90 | — | — | 90 |

TABLE 61

| | Example 5D | | | Example 6D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 25 | −12.5 | 45 & 135 | 25 | −12.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 25 | −12.5 | 135 & 45 | 25 | −12.5 | 45 |
| Second polarizing film | — | — | 90 | — | — | 90 |

TABLE 62

| | Example 7D | | | Example 8D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 400 | — | 0 | 400 | — |
| Fourth retardation layer | 75 | −37.5 | 135 & 45 | 75 | −37.5 | 45 |
| Second polarizing film | — | — | 90 | — | — | 90 |

TABLE 63

| | Example 9D | | | Example 10D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 500 | — | 0 | 500 | — |
| Fourth retardation layer | 75 | −37.5 | 135 & 45 | 75 | −37.5 | 45 |
| Second polarizing film | — | — | 90 | — | — | 90 |

TABLE 64

| | Example 11D | | | Example 12D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −200 | — | 0 | −200 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 45 |
| Second polarizing film | — | — | 90 | — | — | 90 |

TABLE 65

| | Example 13D | | | Example 14D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −100 | — | 0 | −100 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 45 |
| Second polarizing film | — | — | 90 | — | — | 90 |

TABLE 66

| | Example 15D | | | Example 16D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 135 | 75 | −37.5 | 135 |
| Second retardation layer | 0 | −150 | — | 0 | −150 | — |
| Liquid crystal layer | 0 | −250 | 2D | 0 | −450 | 2D |
| Third retardation layer | 0 | 450 | — | 0 | 450 | — |
| Fourth retardation layer | 75 | −37.5 | 45 | 75 | −37.5 | 45 |
| Second polarizing film | — | — | 90 | — | — | 90 |

TABLE 67

| | Example 17D | | | Example 18D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | — | — | 90 |
| | 0 | −160 | — | — | — | — |
| First retardation layer | 75 | −37.5 | 135 | 75 | −37.5 | 135 |
| Second retardation layer | 0 | −150 | — | 0 | −150 | — |
| Liquid crystal layer | 0 | −300 | 2D | 0 | −300 | 2D |
| Third retardation layer | 0 | 450 | — | 0 | 450 | — |
| Fourth retardation layer | 65 | −32.5 | 45 | 75 | −37.5 | 45 |
| Second polarizing film | — | — | 90 | — | — | 90 |

TABLE 68

| | Example 19D | | |
|---|---|---|---|
| | Optical property | | |
| | | | Slow axis or |
| Layer configuration | Re[nm] | Rth[nm] | Absorption axis |
| First polarizing film | — | — | 0 |
| First retardation layer | 75 | −37.5 | 135 |
| Second retardation layer | 0 | −150 | — |
| Liquid crystal layer | 0 | −300 | 2D |
| Third retardation layer | 0 | 450 | — |
| Fourth retardation layer | 75 | −37.5 | 45 |
| Fifth retardation layer | 0 | −160 | — |
| | 100 | 100 | 0 |
| Second polarizing film | — | — | 90 |

TABLE 69

| | Example 20D | | |
|---|---|---|---|
| | Optical property | | |
| | | | Slow axis or |
| Layer configuration | Re[nm] | Rth[nm] | Absorption axis |
| First polarizing film | — | — | 0 |
| Fifth retardation layer | — | — | — |
| | — | — | — |
| First retardation layer | 75 | −37.5 | 135 |
| Second retardation layer | 0 | −150 | — |
| Liquid crystal layer | 0 | −300 | 2D |
| Third retardation layer | 0 | 450 | — |
| Fourth retardation layer | 75 | −37.5 | 45 |
| Second polarizing film | — | — | 90 |

TABLE 70

| | Comparative Example 1D | | | Comparative Example 2D | | | Comparative Example 3D | | |
|---|---|---|---|---|---|---|---|---|---|
| | Optical property | | | Optical property | | | Optical property | | |
| | | | Slow axis or | | | Slow axis or | | | Slow axis or |
| Layer configuration | Re[nm] | Rth[nm] | Absorption axis | Re[nm] | Rth[nm] | Absorption axis | Re[nm] | Rth[nm] | Absorption axis |
| First polarizing film | — | — | 0 | — | — | 0 | — | — | 0 |
| Fifth retardation layer | 100 | 100 | 90 | 100 | 100 | 90 | 100 | 100 | 90 |
| | 0 | −160 | — | 0 | −160 | — | 0 | −160 | — |
| First retardation layer | — | — | — | — | — | — | — | — | — |
| Second retardation layer | 0 | −150 | — | 0 | −150 | — | 0 | −150 | — |
| Liquid crystal layer | 0 | −300 | 8D | 0 | −300 | 4D | 0 | −300 | 2D |
| Third retardation layer | 0 | 450 | — | 0 | 450 | — | 0 | 450 | — |
| Fourth retardation layer | — | — | — | — | — | — | — | — | — |
| Second polarizing film | — | — | 90 | — | — | 90 | — | — | 90 |

TABLE 71

| | Comparative Example 4D | | | Comparative Example 5D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 145 | −72.5 | 45 & 135 | 145 | −72.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 145 | −72.5 | 135 & 45 | 145 | −72.5 | 45 |
| Second polarizing film | — | — | 90 | — | — | 90 |

TABLE 72

| | Comparative Example 6D | | | Comparative Example 7D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 5 | −2.5 | 45 & 135 | 5 | −2.5 | 135 |
| Second retardation layer | 0 | −150 | — | 0 | −150 | — |
| Liquid crystal layer | 0 | −300 | 4D | 0 | −300 | 2D |
| Third retardation layer | 0 | 450 | — | 0 | 450 | — |
| Fourth retardation layer | 5 | −2.5 | 135 & 45 | 5 | −2.5 | 45 |
| Second polarizing film | — | — | 90 | — | — | 90 |

TABLE 73

| | Comparative Example 8D | | | Comparative Example 9D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 550 | — | 0 | 550 | — |
| Fourth retardation layer | 75 | −37.5 | 135 & 45 | 75 | −37.5 | 45 |
| Second polarizing film | — | — | 90 | — | — | 90 |

TABLE 74

| | Comparative Example 10D | | | Comparative Example 11D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −150 | — | 0 | −150 | — |
| Liquid crystal layer | 0 | −300 | 4D | 0 | −300 | 2D |
| Third retardation layer | 0 | 350 | — | 0 | 350 | — |
| Fourth retardation layer | 75 | −37.5 | 135 & 45 | 75 | −37.5 | 45 |
| Second polarizing film | — | — | 90 | — | — | 90 |

TABLE 75

| | Comparative Example 12D | | | Comparative Example 13D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −250 | — | 0 | −250 | — |
| Liquid crystal layer | 0 | −300 | 4D | 0 | −300 | 2D |
| Third retardation layer | 0 | 450 | — | 0 | 450 | — |
| Fourth retardation layer | 75 | −37.5 | 135 & 45 | 75 | −37.5 | 45 |
| Second polarizing film | — | — | 90 | — | — | 90 |

TABLE 76

| | Comparative Example 14D | | | Comparative Example 15D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 45 & 135 | 75 | −37.5 | 135 |
| Second retardation layer | 0 | −50 | — | 0 | −50 | — |
| Liquid crystal layer | 0 | −300 | 4D | 0 | −300 | 2D |
| Third retardation layer | 0 | 350 | — | 0 | 350 | — |
| Fourth retardation layer | 75 | −37.5 | 135 & 45 | 75 | −37.5 | 45 |
| Second polarizing film | — | — | 90 | — | — | 90 |

TABLE 77

| | Comparative Example 16D | | | Comparative Example 17D | | |
|---|---|---|---|---|---|---|
| | Optical property | | | Optical property | | |
| | | | Slow axis or | | | Slow axis or |
| Layer configuration | Re[nm] | Rth[nm] | Absorption axis | Re[nm] | Rth[nm] | Absorption axis |
| First polarizing film | — | — | 0 | — | — | 0 |
| Fifth retardation layer | 100 | 100 | 90 | 100 | 100 | 90 |
| | 0 | −160 | — | 0 | −160 | — |
| First retardation layer | 75 | −37.5 | 135 | 75 | −37.5 | 135 |
| Second retardation layer | 0 | −150 | — | 0 | −150 | — |
| Liquid crystal layer | 0 | −200 | 2D | 0 | −500 | 2D |
| Third retardation layer | 0 | 450 | — | 0 | 450 | — |
| Fourth retardation layer | 75 | −37.5 | 45 | 75 | −37.5 | 45 |
| Second polarizing film | — | — | 90 | — | — | 90 |

In the above tables, the term “2D” indicates a pixel of the liquid crystal cell having two domains, “4D” indicates a pixel of four domains, and “8D” indicates a pixel of eight domains.

The angles of the slow axes and absorption axes are defined such that the absorption axis of the first polarizing film is 0° and the counterclockwise direction as viewed from a viewer is positive.

### <Evaluation>

The resulting liquid crystal display devices were evaluated as below, with a tester “EZ-Contrast XL88” (manufactured by ELDIM).

### <<Whitening>>

The γ curve in a view from the front was determined to be 2.2, such that 100×(each signal value/maximum signal value)^{2.2} equals to a normalized brightness (relative to white brightness of 100) at each signal value. The brightness at a signal value of 128 and the brightness of a white display mode were measured. The ratio (the brightness at the signal value of 128 to the white brightness) was then calculated for each of a view from the front and views from four directions (right, bottom, left, and top (azimuth: 0°, 90°, 180°, and)) 270°)) at a polar angle of 60°. The difference between the ratio for the front and an average ratio for the four directions was calculated, and evaluated based on the following criteria.

A: 0≦difference<0.05
B: 0.05≦difference<0.10
C: 0.10≦difference<0.15
D: 0.15≦difference

### <<Tinting>>

The difference Δu′v′ in tint of the white brightness between a view from the front and a view from the right (azimuth: 0°) at a polar angle of 60° was calculated using the following expression:

Δu′v′=√(u′_right−u′_front)̂2+(v′_right−v′_front)̂2

The calculated difference Δu′v′ was evaluated based on the following criteria.
A: Δu′v′<0.005
B: 0.005≦Δu′v′<0.01
C: 0.01≦Δu′v′

### <<Viewing Angle Contrast (CR)>>

The brightness of a white display mode and that of a black display mode were measured. The average value of the contrast ratios (the white brightness to the black brightness) for views from four diagonal directions (azimuth: 45°, 135°, 225°, and) 315° at a polar angle of 60° was calculated, and evaluated based on the following criteria.

A: 10≦average
B: 5≦average<10
C: average<5

### <<Use Efficiency of Backlight (BL)>>

The brightness of a white display mode and that of the backlight alone were measured, and the ratio thereof (the white brightness to the backlight brightness) was calculated. The proportion of the ratio to that in Comparative Example 1 (the ratio in each example or comparative example to the ratio in Comparative Example 1) was calculated, and evaluated based on the following criteria.

A: 105≦proportion
B: 102.5≦proportion<105
C: 100≦proportion<102.5

### <<Front Contrast (CR)>>

The brightness of a white display mode and that of a black display mode were measured, and the contrast ratio (the white brightness to the black brightness) in a view from the front was calculated. The proportion of the front contrast to that in Comparative Example 1 (the front contrast in each example or comparative example to the front contrast in Comparative Example 1) was calculated, and evaluated based on the following criteria.

A: 98≦proportion
B: 90≦proportion<98
C: proportion<90

The results of the evaluations are shown in the tables below.

TABLE 78

| | Evaluation | | | | |
|---|---|---|---|---|---|
| | | | Viewing | Use | |
| | Whiten- | Tint- | Angle | Efficiency | Front |
| | ing | ing | CR | of BL | CR |
| Example 1A | A | A | A | B | A |
| Example 2A | A | A | A | A | A |
| Example 3A | B | A | A | B | A |
| Example 4A | B | A | A | A | A |
| Example 5A | B | A | A | B | A |
| Example 6A | B | A | A | A | A |
| Example 7A | B | A | B | B | A |
| Example 8A | B | A | B | A | A |
| Example 9A | B | A | B | B | A |
| Example 10A | B | A | B | A | A |
| Example 11A | B | A | B | B | A |
| Example 12A | B | A | B | A | A |
| Example 13A | B | A | B | B | A |
| Example 14A | B | A | B | A | A |
| Example 15A | A | A | A | A | A |
| Example 16A | A | A | B | A | A |
| Example 17A | A | A | A | A | C |
| Example 18A | A | A | C | A | A |
| Example 19A | A | A | A | A | A |
| Example 20A | A | A | A | A | A |
| Comparative Example 1A | C | A | A | C | A |
| Comparative Example 2A | D | A | A | B | A |
| Comparative Example 3A | D | A | A | A | A |
| Comparative Example 4A | C | A | A | B | A |
| Comparative Example 5A | C | A | A | A | A |
| Comparative Example 6A | C | A | A | B | A |
| Comparative Example 7A | C | A | A | A | A |
| Comparative Example 8A | C | A | A | B | A |
| Comparative Example 9A | C | A | A | A | A |
| Comparative Example 10A | C | A | A | B | A |
| Comparative Example 11A | C | A | A | A | A |
| Comparative Example 12A | C | A | A | B | A |
| Comparative Example 13A | C | A | A | A | A |
| Comparative Example 14A | C | A | A | B | A |
| Comparative Example 15A | C | A | A | A | A |
| Comparative Example 16A | C | A | B | B | A |
| Comparative Example 17A | C | A | B | A | A |

TABLE 79

| | Evaluation | | | | |
|---|---|---|---|---|---|
| | | | Viewing | Use | |
| | Whiten- | Tint- | Angle | Efficiency | Front |
| | ing | ing | CR | of BL | CR |
| Example 1B | A | A | A | B | A |
| Example 2B | A | A | A | A | A |
| Example 3B | B | A | A | B | A |
| Example 4B | B | A | A | A | A |
| Example 5B | B | A | A | B | A |
| Example 6B | B | A | A | A | A |
| Example 7B | B | A | B | B | A |
| Example 8B | B | A | B | A | A |
| Example 9B | B | A | B | B | A |
| Example 10B | B | A | B | A | A |
| Example 11B | B | A | B | B | A |
| Example 12B | B | A | B | A | A |
| Example 13B | B | A | B | B | A |
| Example 14B | B | A | B | A | A |
| Example 15B | A | A | A | A | A |
| Example 16B | A | A | B | A | A |
| Example 17B | A | A | A | A | C |
| Example 18B | A | A | C | A | A |
| Example 19B | A | A | A | A | A |
| Example 20B | A | A | A | A | A |
| Comparative Example 1B | C | A | A | C | A |
| Comparative Example 2B | D | A | A | B | A |
| Comparative Example 3B | D | A | A | A | A |
| Comparative Example 4B | C | A | A | B | A |
| Comparative Example 5B | C | A | A | A | A |
| Comparative Example 6B | C | A | A | B | A |
| Comparative Example 7B | C | A | A | A | A |
| Comparative Example 8B | C | A | A | B | A |
| Comparative Example 9B | C | A | A | A | A |
| Comparative Example 10B | C | A | A | B | A |
| Comparative Example 11 B | C | A | A | A | A |
| Comparative Example 12B | C | A | A | B | A |
| Comparative Example 13B | C | A | A | A | A |
| Comparative Example 14B | C | A | A | B | A |
| Comparative Example 15B | C | A | A | A | A |
| Comparative Example 16B | C | A | B | B | A |
| Comparative Example 17B | C | A | B | A | A |

TABLE 80

| | Evaluation | | | | |
|---|---|---|---|---|---|
| | | | Viewing | Use | |
| | Whiten- | Tint- | Angle | Efficiency | Front |
| | ing | ing | CR | of BL | CR |
| Example 1C | A | A | A | B | A |
| Example 2C | A | A | A | A | A |
| Example 3C | B | A | A | B | A |
| Example 4C | B | A | A | A | A |
| Example 5C | B | A | A | B | A |
| Example 6C | B | A | A | A | A |
| Example 7C | B | A | B | B | A |
| Example 8C | B | A | B | A | A |
| Example 9C | B | A | B | B | A |
| Example 10C | B | A | B | A | A |
| Example 11C | B | A | B | B | A |
| Example 12C | B | A | B | A | A |
| Example 13C | B | A | B | B | A |
| Example 14C | B | A | B | A | A |
| Example 15C | A | A | A | A | A |
| Example 16C | A | A | B | A | A |
| Example 17C | A | A | A | A | C |
| Example 18C | A | A | C | A | A |
| Example 19C | A | A | A | A | A |
| Example 20C | A | A | A | A | A |
| Comparative Example 1C | C | A | A | C | A |
| Comparative Example 2C | D | A | A | B | A |
| Comparative Example 3C | D | A | A | A | A |
| Comparative Example 4C | C | A | A | B | A |
| Comparative Example 5C | C | A | A | A | A |
| Comparative Example 6C | C | A | A | B | A |
| Comparative Example 7C | C | A | A | A | A |
| Comparative Example 8C | C | A | A | B | A |
| Comparative Example 9C | C | A | A | A | A |
| Comparative Example 10C | C | A | A | B | A |
| Comparative Example 11C | C | A | A | A | A |
| Comparative Example 12C | C | A | A | B | A |
| Comparative Example 13C | C | A | A | A | A |
| Comparative Example 14C | C | A | A | B | A |
| Comparative Example 15C | C | A | A | A | A |
| Comparative Example 16C | C | A | B | B | A |
| Comparative Example 17C | C | A | B | A | A |

TABLE 81

| | Evaluation | | | | |
|---|---|---|---|---|---|
| | | | Viewing | Use | |
| | Whiten- | Tint- | Angle | Efficiency | Front |
| | ing | ing | CR | of BL | CR |
| Example 1D | A | A | A | B | A |
| Example 2D | A | A | A | A | A |
| Example 3D | B | A | A | B | A |
| Example 4D | B | A | A | A | A |
| Example 5D | B | A | A | B | A |
| Example 6D | B | A | A | A | A |
| Example 7D | B | A | B | B | A |
| Example 8D | B | A | B | A | A |
| Example 9D | B | A | B | B | A |
| Example 10D | B | A | B | A | A |
| Example 11D | B | A | B | B | A |
| Example 12D | B | A | B | A | A |
| Example 13D | B | A | B | B | A |
| Example 14D | B | A | B | A | A |
| Example 15D | A | A | A | A | A |
| Example 16D | A | A | B | A | A |
| Example 17D | A | A | A | A | C |
| Example 18D | A | A | C | A | A |
| Example 19D | A | A | A | A | A |
| Example 20D | A | A | A | A | A |
| Comparative Example 1D | C | A | A | C | A |
| Comparative Example 2D | D | A | A | B | A |
| Comparative Example 3D | D | A | A | A | A |
| Comparative Example 4D | C | A | A | B | A |
| Comparative Example 5D | C | A | A | A | A |
| Comparative Example 6D | C | A | A | B | A |
| Comparative Example 7D | C | A | A | A | A |
| Comparative Example 8D | C | A | A | B | A |
| Comparative Example 9D | C | A | A | A | A |
| Comparative Example 10D | C | A | A | B | A |
| Comparative Example 11D | C | A | A | A | A |
| Comparative Example 12D | C | A | A | B | A |
| Comparative Example 13D | C | A | A | A | A |
| Comparative Example 14D | C | A | A | B | A |
| Comparative Example 15D | C | A | A | A | A |
| Comparative Example 16D | C | A | B | B | A |
| Comparative Example 17D | C | A | B | A | A |

The tables demonstrate that the liquid crystal display devices according to the invention cause less tinting and whitening while maintaining high viewing angle contrast and high front contrast. In contrast, the liquid crystal display devices according to the comparative examples exhibit insufficient contrast, cause tinting, and/or cause whitening.

The present disclosure relates to the subject matter contained in Japanese Patent Application No. 0105645/2013, filed on May 17, 2013, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A liquid crystal display device comprising: a first polarizing film; a first retardation layer; a second retardation layer; a liquid crystal layer; a third retardation layer; a fourth retardation layer; and a second polarizing film, in sequence, wherein
the liquid crystal layer has four domains or less, and is in a vertical alignment mode (VA mode) under no voltage application,
the first and fourth retardation layers each have an in-plane retardation Re (550) of 25 to 125 nm at a wavelength of 550 nm, and have a thickness retardation Rth (550) of 12.5 to 62.5 nm at a wavelength of 550 nm,
the absolute value of a retardation Re (550) of the second retardation layer is not larger than 10 nm, while a retardation Rth (550) of the second retardation layer is −200 to −100 nm,
the absolute value of a retardation Re (550) of the third retardation layer is not larger than 10 nm, while a retardation Rth (550) of the third retardation layer is 300 to 400 nm,
an absorption axis of the first polarizing film is orthogonal to an absorption axis of the second polarizing film,
a slow axis of the first retardation layer defines an angle of 45° from the absorption axis of the first polarizing film, and is parallel to an in-plane slow axis of the liquid crystal layer under voltage application,
the slow axis of the first retardation layer is orthogonal to a slow axis of the fourth retardation layer, and
a product Δn·d of the refractive-index anisotropy Δn and the thickness d (μm) of the liquid crystal layer is 250 to 450 nm.

2. A liquid crystal display device comprising: a first polarizing film; a first retardation layer; a second retardation layer; a liquid crystal layer; a third retardation layer; a fourth retardation layer; and a second polarizing film, in sequence, wherein
the liquid crystal layer has four domains or less, and is in a vertical alignment mode (VA mode) under no voltage application,
the first and fourth retardation layers each have an in-plane retardation Re (550) of 25 to 125 nm at a wavelength of 550 nm, and have a thickness retardation Rth (550) of 12.5 to 62.5 nm at a wavelength of 550 nm,
the absolute value of a retardation Re (550) of the second retardation layer is not larger than 10 nm, while a retardation Rth (550) of the second retardation layer is −300 to −200 nm,
the absolute value of a retardation Re (550) of the third retardation layer is not larger than 10 nm, while a retardation Rth (550) of the third retardation layer is 400 to 500 nm,
an absorption axis of the first polarizing film is orthogonal to an absorption axis of the second polarizing film,
a slow axis of the first retardation layer defines an angle of 45° from the absorption axis of the first polarizing film, and is orthogonal to an in-plane slow axis of the liquid crystal layer under voltage application,
the slow axis of the first retardation layer is orthogonal to a slow axis of the fourth retardation layer, and
a product Δn·d of the refractive-index anisotropy Δn and the thickness d (μm) of the liquid crystal layer is 250 to 450 nm.

3. A liquid crystal display device comprising: a first polarizing film; a first retardation layer; a second retardation layer; a liquid crystal layer; a third retardation layer; a fourth retardation layer; and a second polarizing film, in sequence, wherein
the liquid crystal layer has four domains or less, and is in a vertical alignment mode (VA mode) under no voltage application,
the first and fourth retardation layers each have an in-plane retardation Re (550) of 25 to 125 nm at a wavelength of 550 nm, and have a thickness retardation Rth (550) of −62.5 to −12.5 nm at a wavelength of 550 nm,
the absolute value of a retardation Re (550) of the second retardation layer is not larger than 10 nm, while a retardation Rth (550) of the second retardation layer is −150 to −50 nm,
the absolute value of a retardation Re (550) of the third retardation layer is not larger than 10 nm, while a retardation Rth (550) of the third retardation layer is 400 to 500 nm,
an absorption axis of the first polarizing film is orthogonal to an absorption axis of the second polarizing film,
a slow axis of the first retardation layer defines an angle of 45° from the absorption axis of the first polarizing film, and is parallel to an in-plane slow axis of the liquid crystal layer under voltage application,
the slow axis of the first retardation layer is orthogonal to a slow axis of the fourth retardation layer, and
a product Δn·d of the refractive-index anisotropy Δn and the thickness d (μm) of the liquid crystal layer is 250 to 450 nm.

4. A liquid crystal display device comprising: a first polarizing film; a first retardation layer; a second retardation layer; a liquid crystal layer; a third retardation layer; a fourth retardation layer; and a second polarizing film, in sequence, wherein
the liquid crystal layer has four domains or less, and is in a vertical alignment mode (VA mode) under no voltage application,
the first and fourth retardation layers each have an in-plane retardation Re (550) of 25 to 125 nm at a wavelength of 550 nm, and have a thickness retardation Rth (550) of −62.5 to −12.5 nm at a wavelength of 550 nm,
the absolute value of a retardation Re (550) of the second retardation layer is not larger than 10 nm, while a retardation Rth (550) of the second retardation layer is −200 to −100 nm,
the absolute value of a retardation Re (550) of the third retardation layer is not larger than 10 nm, while a retardation Rth (550) of the third retardation layer is 400 to 500 nm,
an absorption axis of the first polarizing film is orthogonal to an absorption axis of the second polarizing film,
a slow axis of the first retardation layer defines an angle of 45° from the absorption axis of the first polarizing film, and is orthogonal to an in-plane slow axis of the liquid crystal layer under voltage application,
the slow axis of the first retardation layer is orthogonal to a slow axis of the fourth retardation layer, and
a product Δn·d of the refractive-index anisotropy Δn and the thickness d (μm) of the liquid crystal layer is 250 to 450 nm.

5. The liquid crystal display device according to claim 1, wherein at least one of the first retardation layer, the second retardation layer, the third retardation layer, and the fourth retardation layer comprises an optically anisotropic layer containing a liquid crystalline compound.

6. The liquid crystal display device according to claim 2, wherein at least one of the first retardation layer, the second retardation layer, the third retardation layer, and the fourth retardation layer comprises an optically anisotropic layer containing a liquid crystalline compound.

7. The liquid crystal display device according to claim 3, wherein at least one of the first retardation layer, the second retardation layer, the third retardation layer, and the fourth retardation layer comprises an optically anisotropic layer containing a liquid crystalline compound.

8. The liquid crystal display device according to claim 4, wherein at least one of the first retardation layer, the second retardation layer, the third retardation layer, and the fourth retardation layer comprises an optically anisotropic layer containing a liquid crystalline compound.

9. The liquid crystal display device according to claim 1, further comprising a fifth retardation layer between the first polarizing film and the first retardation layer or between the second polarizing film and the fourth retardation layer.

10. The liquid crystal display device according to claim 2, further comprising a fifth retardation layer between the first polarizing film and the first retardation layer or between the second polarizing film and the fourth retardation layer.

11. The liquid crystal display device according to claim 3, further comprising a fifth retardation layer between the first polarizing film and the first retardation layer or between the second polarizing film and the fourth retardation layer.

12. The liquid crystal display device according to claim 4, further comprising a fifth retardation layer between the first polarizing film and the first retardation layer or between the second polarizing film and the fourth retardation layer.

13. The liquid crystal display device according to claim 5, further comprising a fifth retardation layer between the first polarizing film and the first retardation layer or between the second polarizing film and the fourth retardation layer.

14. The liquid crystal display device according to claim 6, further comprising a fifth retardation layer between the first polarizing film and the first retardation layer or between the second polarizing film and the fourth retardation layer.

15. The liquid crystal display device according to claim 7, further comprising a fifth retardation layer between the first polarizing film and the first retardation layer or between the second polarizing film and the fourth retardation layer.

16. The liquid crystal display device according to claim 8, further comprising a fifth retardation layer between the first polarizing film and the first retardation layer or between the second polarizing film and the fourth retardation layer.

17. The liquid crystal display device according to claim 9, wherein the fifth retardation layer is a laminated film comprising:
a film having a retardation Re (550) of 70 to 140 nm and a retardation Rth (550) of 40 to 110 nm; and
a film having a retardation Re (550) of not larger than 10 nm and a retardation Rth (550) of −180 to −90 nm.

18. The liquid crystal display device according to claim 10, wherein the fifth retardation layer is a laminated film comprising:
a film having a retardation Re (550) of 70 to 140 nm and a retardation Rth (550) of 40 to 110 nm; and
a film having a retardation Re (550) of not larger than 10 nm and a retardation Rth (550) of −180 to −90 nm.

19. The liquid crystal display device according to claim 11, wherein the fifth retardation layer is a laminated film comprising:
a film having a retardation Re (550) of 70 to 140 nm and a retardation Rth (550) of 40 to 110 nm; and
a film having a retardation Re (550) of not larger than 10 nm and a retardation Rth (550) of −180 to −90 nm.

20. The liquid crystal display device according to claim 12, wherein the fifth retardation layer is a laminated film comprising:
a film having a retardation Re (550) of 70 to 140 nm and a retardation Rth (550) of 40 to 110 nm; and
a film having a retardation Re (550) of not larger than 10 nm and a retardation Rth (550) of −180 to −90 nm.
